(19) United States
(12) Patent Application Publication
(10) Pub. No.: US 2011/0233219 A1
(43) Pub. Date: Sep. 29, 2011

(54) Drinking Mug Having A Thermal Heatsink For Maintaining A Beverage Temperature

(76) Inventor: Christopher Adam Proskey, Des Moines, IA (US)

(21) Appl. No.: 13/151,563

(22) Filed: Jun. 2, 2011

Related U.S. Application Data
(63) Continuation-in-part of application No. 12/723,245, filed on Mar. 12, 2010.
Application No. 12/723,245 is a continuation-in-part of application No. 12/619,248, filed on Nov. 16, 2009.

(51) Int. Cl. A47J 41/00

(52) U.S. Cl. 220/592.17

(57) ABSTRACT

A drinking mug assembly comprising a bottom having a top surface and a bottom surface, a sidewall connected to the bottom having an exterior surface and an interior surface, having a top end and a bottom end. A beverage area positioned above the bottom and a cavity positioned below the sidewall. A heatsink positioned within the cavity and a lid removably and replaceably connected to the mug which holds the heatsink within the cavity in place.

### CROSS REFERENCE TO RELATED APPLICATION

This application is a continuation-in-part of application Ser. No. 12/723,245 filed Mar. 12, 2010, which is a continuation-in-part of application Ser. No. 12/619,248 filed Nov. 16, 2009.

### BACKGROUND OF THE INVENTION

This invention relates to a drinking mug. More specifically and without limitation, this invention relates to a drinking mug having a thermal heatsink for maintaining a beverage temperature.

Since the dawn of the refrigeration age people have been drinking cool beverages because they are more refreshing than room temperature or warm beverages. This is especially true in warm environments. However, when a cool beverage is poured into a warm drinking mug the drinking mug acts to warm-up the beverage, which reduces the level of refreshment the drinker receives from consuming the beverage, and/or leads to consuming the beverage faster and all the negative affects that follow there from.

To overcome these problems many systems and methods have been developed, including: insulated cups and mugs often made of a light-metal, foam and/or plastic material. Although these systems have their advantages, particularly by insulating the beverage, they do not absorb much energy when placed in a refrigerator or freezer. Additionally, these systems do not have the aesthetic properties of a traditional drinking mug made of glass.

Alternatively, ice cubes were developed to place in a beverage to cool it down. Although this method has its advantages, ice cubes melt and dilute the beverage. Additionally, any material, odors or impurities in the ice cube end up in the beverage. To solve this problem plastic covered ice cubes were developed. However, plastic covered ice cubes are not very aesthetically pleasing, and after several iterations of freezing and thawing they tend to break and leak the questionable fluid inside them into the beverage itself. Additionally, due to the absorptive nature of plastic, these plastic ice cubes tend to pick up odors from their environment, such as previous beverages or the freezer in which they are stored, which they then deposit into the beverage.

Alternatively, to ensure that a beverage is not warmed when placed in a drinking mug many drinkers place solid, thick and/or heavy glass drinking mugs in the refrigerator or freezer to make them cool. When it is time to drink the user removes the drinking mug from the freezer or refrigerator and pours the beverage into the cool drinking mug. This method provides the aesthetic benefits of enabling a drinker to drink from a traditional glass drinking mug while not warming the beverage. Additionally, the method does not dilute the beverage or place the risk of disbursing any impurities or contaminates into the beverage. Additionally, the heavier the drinking mug and the cooler the temperature of the drinking mug, the longer the drinking mug will help maintain a cool temperature of the beverage. Additionally, the “frosty-mug” affect is very aesthetic pleasing. This phenomenon occurs when a user removes a drinking mug that is below the freezing temperature of water from a freezer. This causes humidity from the surrounding warm environment to condense on the drinking mug and freeze into a layer of frost which is aesthetically pleasing. Additionally, if the drinking mug is below the freezing temperature of the beverage itself, a layer of beverage will condense into a solid on the inside of the drinking mug which is also aesthetically pleasing.

This method, however, has its disadvantages. First, the thermal properties of glass itself—although somewhat favorable for this method—do not maintain the temperature of the drinking mug for a very long time (i.e., the glass tends to quickly absorb energy from the environment). Therefore, the drinking mug and the beverage tend to warm up quickly and thus the “frosty-mug” affect is unfortunately short-lived.

Despite these advances in maintaining the temperature of a beverage, problems still exist. In particular, problems regarding a drinking mug and method of using said drinking mug that is aesthetically pleasing and maintains the temperature of beverage have not been addressed.

Thus, it is a primary object of the present invention to provide a drinking mug that maintains the temperature of the beverage that improves upon the state of the art.

Another object of the present invention is to provide a drinking mug having a heatsink that helps maintain the temperature of the beverage.

Yet another object of the present invention is to provide a drinking mug having a heatsink that is shielded by an insulting material towards the environment yet unshielded towards the beverage such that thermal preference is given towards maintaining the temperature of a beverage instead of being expelled into the environment.

A further object of the present invention is to provide a drinking mug having a heatsink that extends the longevity of the temperature of a drinking mug over the prior art.

Yet another object of the present invention is to provide a method for achieving the above objectives.

A further object of the present invention is to provide a drinking mug that has a weight in the bottom such that the drinking mug is heavier than conventional drinking mugs and is very appealing especially to many masculine beer consumers.

Yet another object of the present invention is to provide a drinking mug that has a disproportionate amount of weight towards the bottom of the drinking mug (i.e. the bottom of the drinking mug is at least twice as heavy as the top half of the drinking mug) such that the drinking mug has a tendency to stay upright, is well balanced for the drinker and is more difficult to spill accidentally.

It will be appreciated by those skilled in the art that other various modifications could be made to the device without departing from the spirit and scope of this invention. All such modifications and changes fall within the scope of the claims and are intended to be covered thereby.

### BRIEF SUMMARY OF THE INVENTION

A drinking mug comprising a bottom having a top surface and a bottom surface, a sidewall connected to the bottom having an exterior surface and an interior surface, having a top end and a bottom end. A beverage area defined by the bottom and sidewall for containing a beverage. A heatsink connected to the bottom having a heatsink top surface and a heatsink bottom surface. The heatsink being made of a material that is denser than the material the bottom and sidewalls are made of.

### BRIEF DESCRIPTION OF THE DRAWINGS

FIG. 1 is a side view of a drinking mug having a heatsink in the bottom.

FIG. 2 is a side view of a drinking mug having a heatsink having an insulating material.

FIG. 3 is a side view of a drinking mug having a heatsink having a horizontal and vertical portion.

FIG. 4 is a side view of a drinking mug having a heatsink having a horizontal and vertical portion, with a sidewall having a thicker and thinner portion.

FIG. 5 is a side view of a drinking mug having a plurality of unconnected heatsink fingers.

FIG. 6 is a side view of a drinking mug having a heatsink having a plurality of connected heatsink fingers.

FIG. 7 is a side view of a drinking mug having a heatsink having fingers which extend straight upward to a point.

FIG. 8 is a side view of a drinking mug having a heatsink having fingers which extend curvedly upward to an end.

FIG. 9 is a side view of a drinking mug having a heatsink having fingers which get thinner as they extend upward.

FIG. 10 is a side view of a drinking mug having a heatsink in the form of a logo in the sidewall.

FIG. 11 is a top view of a drinking mug having a heatsink in the form of a logo in the bottom.

FIG. 12 is a side view of a drinking mug having a heatsink having threads which is removeably threaded into the bottom.

FIG. 13 is a side view of a drinking mug having a heatsink having a groove which is non-removeably connected to the bottom.

FIG. 14 is a side view of a drinking mug having a heatsink having which is covered on the bottom, sides and part of the top by an insulating material.

FIG. 15 is a side view of a drinking mug having a heatsink having a horizontal and vertical portion which is covered on the bottom and part of the sides by an insulating material.

FIG. 16 is a side view of a drinking mug having a heatsink in the form of a plurality of rings.

FIG. 17 is a side view of a drinking mug having a heatsink positioned within a cavity below the bottom of mug having a groove, the heatsink being surrounded by a filler which fills the groove.

FIG. 18 is a side view of a drinking mug having a heatsink positioned within a cavity below the bottom of mug having a lip, the heatsink being surrounded by a filler which engages the lip.

FIG. 19 is a side view of a drinking mug having a heatsink which is held in place by a lid.

FIG. 20 is a side view of a drinking mug assembly having a heatsink and a shield.

FIG. 21 is a side view of a drinking mug assembly having a snap fit design.

### DETAILED DESCRIPTION OF THE PREFERRED EMBODIMENT

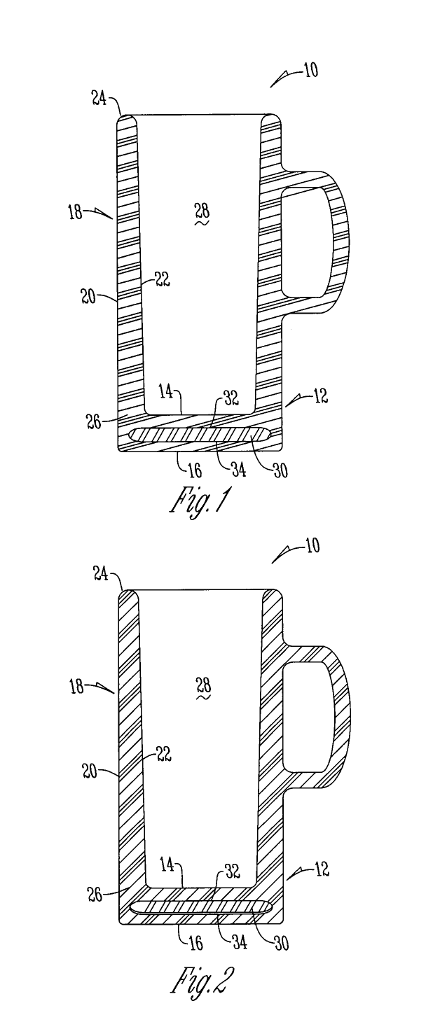

With reference to FIG. 1 a drinking mug 10 has a bottom 12 having a top surface 14 and a bottom surface 16. The drinking mug 10 has a sidewall 18 having an exterior surface 20 and an interior surface 22, and a top open end 24 and a bottom closed end 26. The sidewall 18 extends from the top open end 24 to the bottom closed end 26 where the sidewall 18 is connected to the bottom 12, which defines a hollow interior or beverage area 28 for receiving a beverage. The drinking mug 10 has a heatsink 30 having a heatsink top surface 32 and a heatsink bottom surface 34. The heatsink 30 being made of a material that is denser, heavier and/or has a lower specific heat capacity than the material bottom 12 and the sidewall 18 are made of. Otherwise, the heatsink 30 is a made of a metallic material, a phase change material (PCM), a gel or thermal gel or any other material as is further described herein. The heatsink is contained within the top surface 14 and the bottom surface 16 of the bottom 12. As shown in FIG. 1, the heatsink resides completely within the bottom 12 and is enclosed by the material the drinking mug 10 and/or the bottom 12 are made of. However, the heatsink 30 can likewise reside completely in the sidewall 18. Additionally, in a preferred embodiment the drinking mug 10, including heatsink 30, sidewall 18, and bottom 12 are cylindrical in shape. Additionally, in a preferred embodiment the heatsink 30 is a single piece. Alternatively heatsink 30 is made of multiple pieces or layers or components or is an assembly as is described herein.

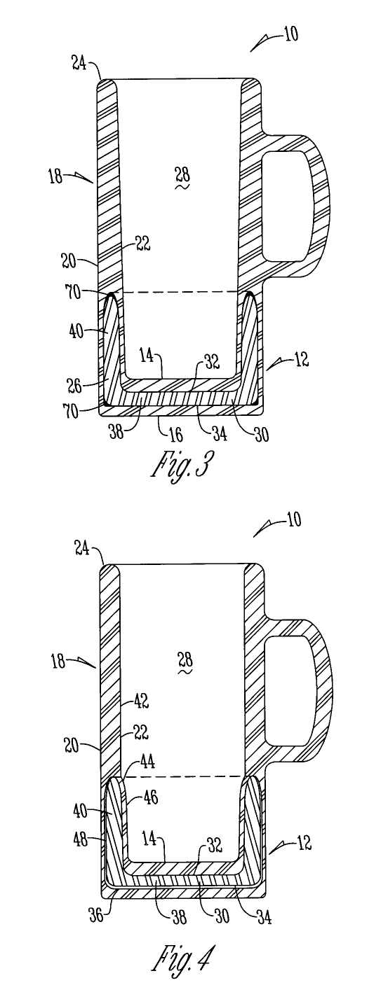

With reference to FIG. 2, the drinking mug 10 has a heatsink 30 having an insulating material 36 on the heatsink bottom surface 34, or a surface facing away from the beverage area 28.

With reference to FIG. 3, the drinking mug 10 has a heatsink 30 having a horizontal portion 38 having a heatsink top surface 32 and a heatsink bottom surface 34 which is contained within the top surface 14 and the bottom surface 16 of the bottom 12. The heatsink 30 of FIG. 3 also has a vertical portion 40 which extends up the drinking mug 10 sidewall 18 which is contained within the exterior surface 20 and the interior surface 22 of the sidewall 18. The heatsink vertical portion 40 is connected at the exterior edge of the heatsink horizontal portion 38.

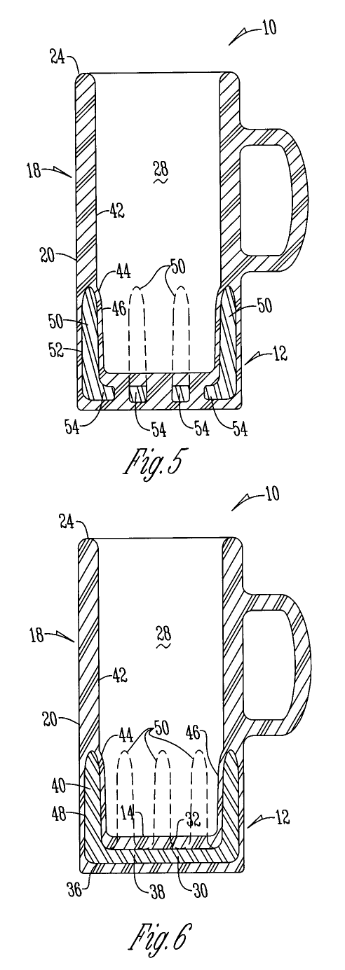

With reference to FIG. 4, the drinking mug 10 has a heatsink 30 having a horizontal portion 38 and a vertical portion 40. The sidewall 18 of the drinking mug 10 has a thin portion 42 where the sidewall 18 does not cover the vertical portion 40 of the heatsink 30, a thick portion 46 where the sidewall 18 covers the vertical portion 40 of heatsink 30, and a transition portion 44 between the thin portion 42 and the thick portion 46. In an alternative embodiment, as shown in FIG. 3, the sidewall 18 of the drinking mug 10 is of a constant thickness regardless if the sidewall 18 is covering the vertical portion 40 of heatsink 30. Additionally, FIG. 4 shows the insulating material 36 on the heatsink exterior surface 48 of the vertical portion 40 of heatsink 30 as well as on the heatsink bottom surface 34.

With reference to FIG. 5, the drinking mug 10 has a plurality of heatsink fingers 50. Fingers 50 have a finger bottom portion 54 which resides in bottom 12 of drinking mug 10 and finger vertical portion 52 which resides in sidewall 18 of drinking mug 10. Alternatively, heatsink fingers 50 reside entirely in the sidewall 18 of drinking mug 10, or entirely in the bottom 12 of drinking mug 10.

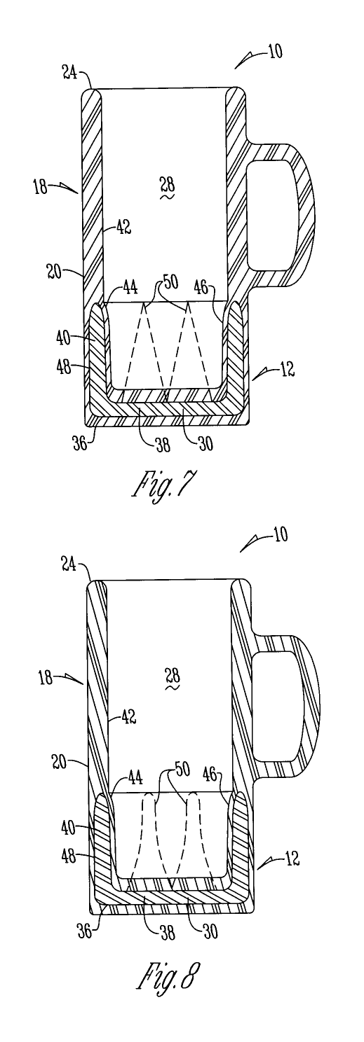

With reference to FIG. 6, the drinking mug 10 has a heatsink 30 with a horizontal portion 38 contained within the bottom 12 of drinking mug 10. Connected at the exterior edge of the heatsink horizontal portion 38 are a plurality of fingers 50 which extend upwardly from the horizontal portion 38 of heatsink 30 in sidewall 18 of drinking mug 10.

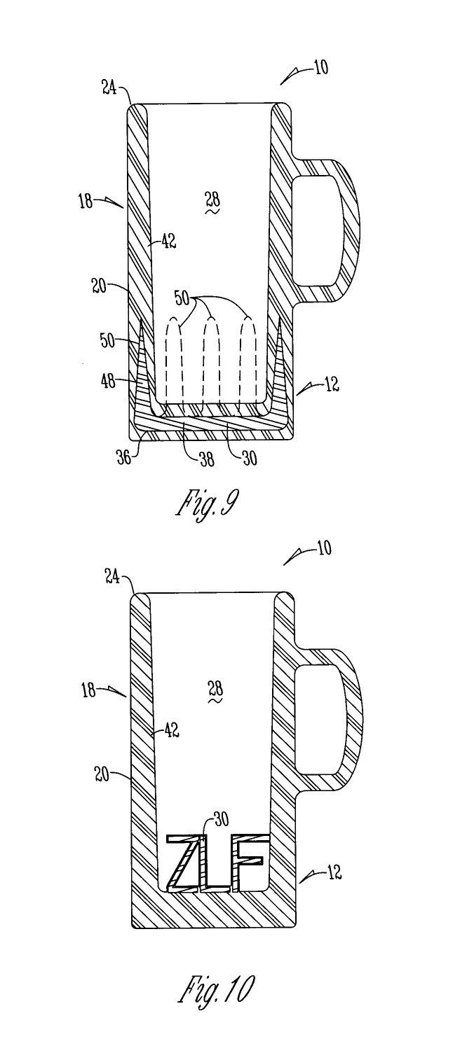

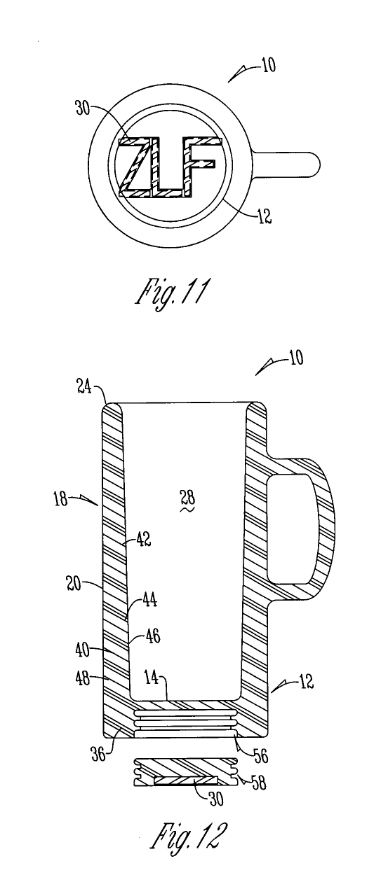

With reference to FIG. 7, the drinking mug 10 has heatsink 30 with horizontal portion 38 connected to a plurality of fingers 50 which extend upwardly at an angle in a straight fashion to a point. Similarly, with reference to FIG. 8, the drinking mug 10 has a heatsink 30 with a horizontal portion 38 connected to a plurality of fingers 50 which extend upwardly in a curved fashion to an end. Additionally, the heatsink may take on many different forms and aesthetic designs and still achieve the same objectives. Similarly, with reference to FIG. 9, as the plurality of fingers 50 extends upwardly the mass of the heatsink material decreases, i.e., they get thinner within the sidewall 18.

With reference to FIGS. 7, 8 and 9, as fingers 50 extend upwardly the amount of heatsink material lessens, i.e., the higher the fingers 50 extend the less heatsink 30 material is present. This reduction of heatsink material as you go up, or increase in heatsink material as you go down, is to facilitate proper cooling of the beverage and balance of the drinking mug 10.

With reference to FIGS. 10 and 11, the heatsink 30 takes the form of a logo, any logo. The logo may be in the form of letters, a name, an emblem, a design. In FIG. 10 the logo resides in the sidewall 18 of drinking mug 10. In FIG. 11 the heatsink 30 logo resides in the bottom 12 of drinking mug 10. Alternatively, the heatsink 30 contains a logo. Alternatively, the logo is attached to the heatsink 30, etched into the heatsink 30, painted onto the heatsink 30, or placed on or by the heatsink 30 in any other way as known in the art.

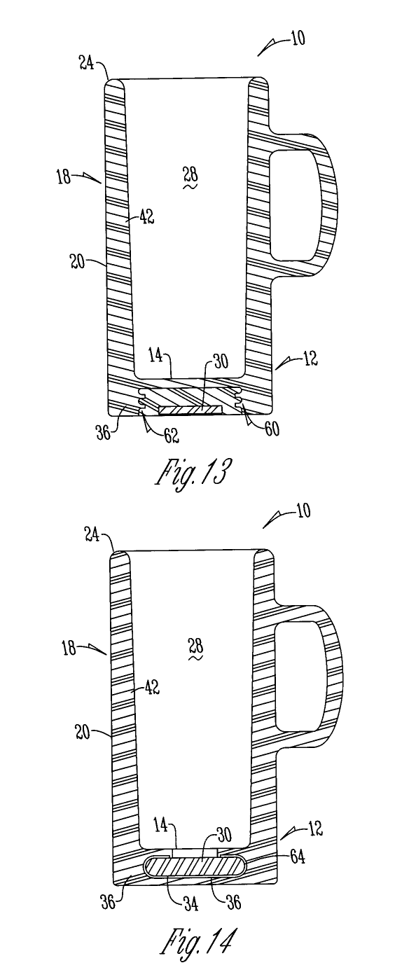

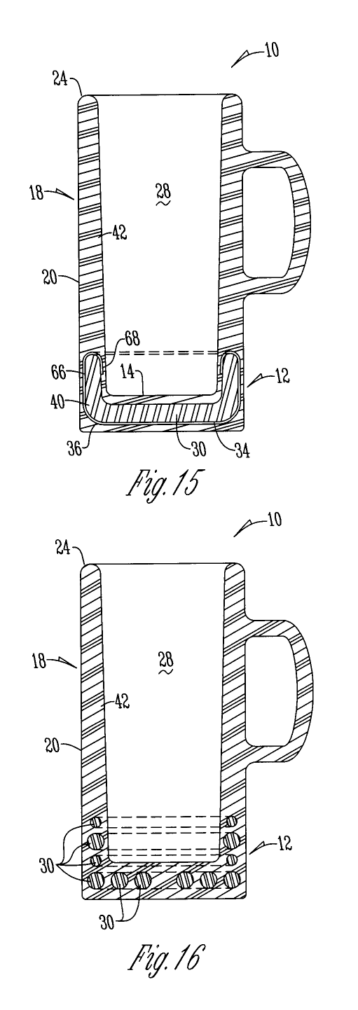

In an alternative embodiment, with reference to FIG. 12, a drinking mug 10 has a bottom 12 having a plurality of threads 56. Correspondingly, heatsink 30 has a plurality of heatsink threads 58 such that the heatsink 30 can be removeably threaded into the bottom 12 of drinking mug 10. Alternatively, with reference to FIG. 13 a drinking mug 10 has bottom 12 having at least one groove 60 or flange. Correspondingly, heatsink 30 has at least one grove 62 such that heatsink 30 and bottom 12 matingly receive one another in a non-removable fashion.

With reference to FIG. 14, heatsink 30 has an insulting material 36 covering the heatsink bottom surface 34 and the heatsink side surface 64 and partially covering the heatsink top surface 32. In this embodiment the heatsink top surface 32 has a non insulated portion.

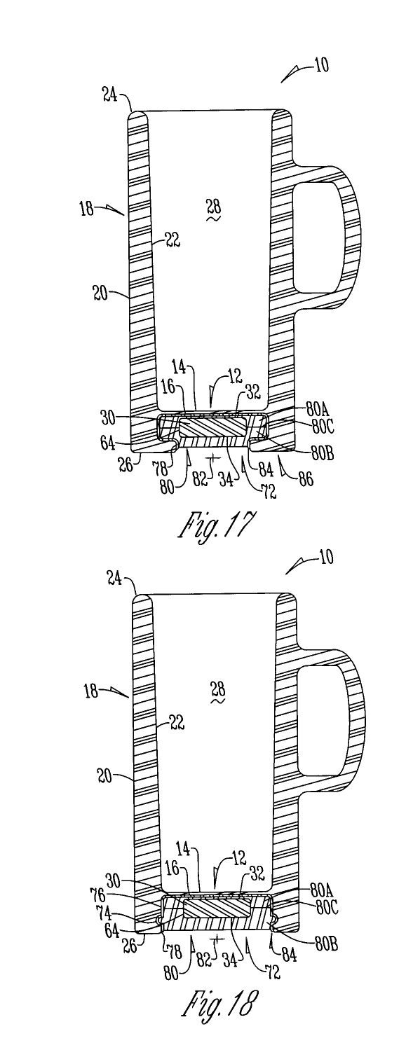

Similarly, with reference to FIG. 15, heatsink 30 has an insulating material 36 covering the heatsink bottom surface 34 and the exterior surface 66 of the vertical portion 40 of heatsink 30. This insulating material can extend over the top of the vertical portion 40 of heatsink 30 and partially down the inside surface 68 of the vertical portion 40 of heatsink 30.

With reference to FIG. 16, the heatsink 30 takes the form of a plurality of rings of heatsink material. These rings reside entirely within the sidewall 18, entirely within the bottom 12, or both within the sidewall 18 and the bottom 12. These rings may extend parallel to the bottom 12 or at an angle to the bottom 12.

The heatsink 30 is made of a material that has favorable thermal properties such that when the drinking mug 10 is placed in a refrigerator or freezer the drinking mug material and the heatsink material release their heat energy to the cooler surroundings in the refrigerator or freezer. However, because of the favorable thermal properties of the heatsink material, the heatsink 30 releases more energy than the drinking mug material. Many materials can be used that release more energy than the drinking mug material. In addition the rate or speed at which the heatsink releases, exchanges or absorbs energy is also a factor. This property is known as diffusivity. The higher the rate of diffusivity the quicker the heatsink will warm up (or the quicker the heatsink will cool down the beverage). As an example, copper receives energy more quickly than aluminum, aluminum receives energy more quickly than steel. This means that a copper heatsink will cool your beverage down more quickly however a steel heatsink will keep your beverage cooler for longer. For optimum performance the specific heat capacity and the rate of diffusivity of the material of the heatsink should be properly chosen and balance for optimum performance. In addition the quantity of heatsink material will affect its cooling capacity. The greater the quantity of heatsink material the greater its ability to cool or keep the beverage cool.

The Second Law of Thermodynamics says that heat will spontaneously flow from a hot object to a cooler one, such that the drinking mug releases its heat energy to the cooler surroundings in the refrigerator or freezer. The specific heat capacity is a constant of proportionality for a particular material that tells how much heat energy it takes to change the temperature of the substance.

For example, lead has a heat capacity of 26.6 J/(mol K). Therefore, to raise the temperature of 1 mol (207 g) of lead by one degree Kelvin, 26.6 J of heat energy would have to be put into the material.

On the other hand, the heat capacity of most glasses is around 50 J/(mol K), therefore to raise the temperature of the same mass of glass (207 g=3.45 mol) by one degree kelvin, (3.45 mol SiO2) (50 J/(mol K)) (1 K)=173 J of heat energy would have to be put in.

In operation, the heatsink material loses less heat energy than the drinking mug material because of the specific heat capacity properties of the two materials.

When the drinking mug 10 is removed from the refrigerator or freezer, both the heatsink material and the drinking mug material are the same (low) temperature. When a beverage (liquid) is poured into the drinking mug 10, the beverage is insulated by the drinking mug material, but since the heatsink material will accept heat more “easily” because of its lower heat capacity, the drinking mug material itself is kept cooler by the presence of the heatsink material. If the drinking mug material stays cooler, then the liquid will stay cooler longer as well.

It's not at all unlike the observation that climates are more temperate near large bodies of water. The water changes temperature much more slowly than the ground because the water has a higher heat capacity (it takes more heat energy to change the temperature of water). The ground changes temperature faster, because it takes less heat to change its temperature (i.e. it has a lower heat capacity). In such a case, the water keeps the ground warmer or cooler than it would otherwise be. As such the larger the heatsink, the cooler it will keep the beverage for longer.

For example, and without limitation, if the drinking mug 10 is made out of a glass material the heatsink 30 could be made of lead or a metal alloy that absorbs more energy than the glass material. This arrangement, as an example, would achieve the above stated objectives. As would a heatsink made of copper, aluminum, steel, gel, thermal gel, PCM, or any other similar materials.

A heatsink material should also be chosen based on its thermal expansion coefficient such that the thermal expansion coefficient of the glass material should be compatible with the thermal expansion coefficient of the heatsink material. That is, through the iterative process of cooling and warming of the drinking mug 10, the glass material and the heatsink material will contract and expand differently. To minimize this, two materials should be chosen that are compatible, such that internal stresses are limited. Additionally, to assist in limiting these internal stresses, specific geometries of the heatsink 30 should be chosen to limit the effect of heatsink expansion and contraction within the glass material. This includes rounding or chamfering all edges or corners on the heatsink 30. Also, the heatsink 30 and drinking mug 10 can be tempered or heat treated to limit these stresses. Also, a buffering material 70 can be placed around the heatsink 30 or at least in the necessary places to buffer the affects of the varying expansion and contraction of the drinking mug material and the heatsink material. Buffering material 70 can be of any compressible material as is described herein that can absorb the expansion and contraction forces of drinking mug 10. See, for example, FIG. 3 where buffering material 70 is placed at the top of the vertical portion 40 of the heatsink 30 and the exterior bottom edge of the horizontal portion 38 of heatsink 30. Alternatively, the buffering material 70 completely surrounds a surface of the heatsink 30, or the entire heatsink 30. The buffering material can be made of any compressible material.

In a preferred embodiment, heatsink 30 weighs a substantial amount. As an example, the addition of the heatsink adds 10% more weight to the mug 10. Alternatively, the heatsink 30 adds: 20%, 30%, 40%, 50%, 60%, 70%, 80%, 90%, 100%, 150%, 200%, 250%, 300%, or the like amount of more weight to the mug assembly 10. The more weight the heatsink 30 adds, the more cooling capacity the heatsink 30 will have. In addition, with the heatsink 30, and therefore the substantial weight thereof, being positioned near the bottom 12 or base of the mug assembly 10, this weight gives the mug assembly a functional and aesthetically pleasing low center of gravity. The low end weight aesthetically feels good in the user's hands. In addition, this makes the mug assembly 10 more difficult to tip over because the weight thereof is proportionally positioned near the bottom of the mug 10. Preferably 25%-80% of the weight of the mug assembly is positioned near the bottom 12 of the mug assembly, or in the bottom 20%-30% of the mug assembly. As described above, the material of heatsink 30 is heavier, denser and has a higher heat capacity than the material of the mug 10 itself. That is, as an example, if the mug 10 is made of a glass material, the heatsink can be made of lead, aluminum, tungsten, copper, pewter, iron, stainless cold rolled steel, brass, or any other metal, composite, or the like materials. Other materials may include a thermal gel, Phase Change material (PCM), water or other materials as is described further herein.

In operation, a user takes a room temperature drinking mug 10 having a heatsink 30 and places it in a freezer or refrigerator, (in this example, a freezer). The drinking mug 10 and heatsink 30 release their heat energy to the freezer. The drinking mug material releases energy to the freezer but the heatsink material releases a considerably greater amount of energy due to the favorable thermal properties of the heatsink material. When the drinking mug 10 and heatsink 30 has reached the ambient temperature of the freezer the user removes the drinking mug 10 from the freezer and pours a beverage into the beverage area 28. The cool (in comparison to the environment) drinking mug 10 and heatsink 30 absorb energy from the beverage. However, due to the thermal properties of the heatsink material the heatsink 30 absorbs more energy from the beverage than the drinking mug material. If the heatsink 30 has an insulating material 36 on the surface facing the environment then the heatsink is shielded from the warm environment such that the heatsink 30 receives more heat energy from the beverage and not the surrounding environment. In this way the drinking mug 10 having a heatsink 30 maintains a beverage temperature better and longer than the prior art glasses.

Accordingly, the drinking mug 10 having a thermal heatsink described herein offers many advantages over the prior art including providing an aesthetically pleasing drinking mug which maintains the temperature of a beverage better than the prior art.

In another embodiment, with reference to FIG. 12, a single annular groove 56, or a plurality of grooves or notches 56 are located in the bottom 12 of the drinking glass 10. In this embodiment the drinking glass 10 is made of a glass or another first material. After the drinking glass 10 is created, a heatsink 30 is placed in the bottom 10 of the drinking glass. Once the heatsink 30 is in place, a liquid or flowable material or binder or second material is poured into the bottom 12 of the drinking glass 10 to fill the remaining area, space or depression in the bottom of the drinking glass 10. Once this liquid hardens it seals and locks the heatsink 30 in place because the liquid material or binder fills the grooves 56 and thereby cannot come out the bottom of the drinking glass 10. This liquid material or binder also acts as an insulating material thereby directing the energy into the bottom 12 of the drinking glass 10 and shielding the surrounding environment. In this arrangement, the drinking glass can be made of glass whereas the liquid material or binder can be an acrylic material, plastic material, fiberglass material, urethane material, polyurethane material or any other material that can flow in a liquid or semi-liquid state and solidify in a solid state thereby locking the heatsink 30 in place. Alternatively the material of the drinking glass 10 and the liquid material or binder are made from the same material.

In another embodiment, with reference to FIG. 18, a drinking glass 10 is presented having a bottom 12 having a top surface 14 and a bottom surface 16 and a sidewall 18 which extends around bottom 12. Sidewall 18 extends downwardly past bottom 12 thereby defining a beverage area 28 above the top surface 14 of bottom 12, and a cavity 72 below the bottom surface 16 of bottom 12. That is, the bottom end 26 of sidewall 18 extends past and below bottom 12 thereby defining cavity 72. Cavity 72 is bounded at its top side by bottom surface 16 of bottom 12, and at its sides by the interior surface 22 of sidewall 18.

Located in the interior surface 22 of sidewall 18 within cavity 72 is cavity groove 74. Cavity groove 74 is a smooth annular groove which extends all the way around the interior surface 22 of sidewall 18. Alternatively, groove 74 does not extend all the way around the interior surface 22 of sidewall 18. Alternatively, groove 74 is a single notch, deviation or indentation into or out of the interior surface 22 of sidewall 18, or a plurality thereof. Cavity groove 74 is preferably rounded, so as to take the shape of % of an o-ring embedded within the sidewall. Alternatively, cavity groove 74 is squared, rectangular, triangular, oval or any other geometric shape. Alternatively there are a plurality of cavity grooves 74 within sidewall 18. Cavity groove 74 provides a footing to hold heatsink 30 into cavity 74.

At least a portion of interior surface of cavity 72 is rough or abraded 76 so as to better hold heatsink 30 into cavity 74. The rough or abraded surface 76 is sanded, sand blasted, scratched, scraped, roughened, chemically burned, chemically etched, diamond patterned, shark skin patterned, checkered, laser cut, or any other form or method of roughening the typically smooth surface of the glass 10 and providing an improved surface for adhesion to the glass. The abraded surface 76 extends across the entire interior surface of cavity 72 including the interior surface 22 of sidewall 18 and the bottom surface 16 of bottom 12 as well as the surface of cavity groove 74. Alternatively, the abraded surface 76 only includes the interior surface 22 of sidewall 18 of cavity 74. In another embodiment only the surface of cavity groove 74 has an abraded surface 76. Alternatively, the abraded surface 76 extends down the interior surface 22 of sidewall 18, past and including cavity groove 74 and terminates at transition point 78 below cavity groove 74 and above the bottom end 26 of sidewall 18. At this transition point 78 the interior surface 22 of sidewall 18 transitions from an abraded 76 surface to smooth surface like the other portions of glass 10.

Heatsink 30, as described above, is positioned within cavity 74. Heatsink 30 is held into place by filler 80. In one embodiment heatsink 30, which is preferably a solid heavy, dense metallic ingot such as lead, magnesium, copper, pewter, tungsten, taconite, steel, iron, depleted uranium, platinum or any other metallic material or composite or any other material with a high heat capacity as described previously, with the heatsink top surface 32 of which is placed in direct contact with the bottom surface 16 of bottom 12. In this way energy is easily transferred between heatsink 30, through bottom 12 and into or out of the beverage in beverage area 28. In this embodiment a single layer of filler 80 is then poured into cavity 72 (when mug 10 is in an inverted or up-side-down position) on top of the heatsink bottom surface 34. This filler 80 fills the remaining area of cavity 72 in a liquid or flowable state, but later transitions into a solid when cured by way of exposure to time, air, room temperature, elevated temperature, light, ultra-violet light, any other wavelength of light, chemicals, any other form of radiation, or any other method of curing or combination thereof. As the filler 80 flows over and around heatsink 30 and fills the remaining area of cavity 72 including cavity groove 80, once solidified filler 80 holds heatsink 30 solidly in cavity 72 and prevents not only removal of heatsink 30, but filler 80 prevents heatsink 30 from rattling, shifting, moving or being loose in any way. In one embodiment heatsink 30 is form fitted to fill the entire area, within close tolerances, to the interior surface 22 of sidewall 18 such that when filler 80 is poured on top of heatsink 30, filler 80 does not penetrate between heatsink 30 and the interior surface 22 of sidewall 80, and therefore filler 80 only exists below the bottom surface 34 of heatsink 30. In this embodiment the lateral position of heatsink 30 is held in place by way of the close tolerances between heatsink 30 and cavity 72, as well as the locking force of filler 80. As thermal expansion issues may exist between the mug 10 and heatsink 30 due to the close tolerances of this embodiment, the exterior edges 64 of heatsink 30, or any other portion of heatsink 30 may be covered in a compressible or buffering material 70 to take up some of this expansion and contraction, as described above. Also or alternatively, the side surface 64 and/or bottom surface 34 of heatsink 30 is covered in an insulating material 36, such as described above, so as to insulate heat skink 30 from the environment and direct energy exchange between beverage area 28 and heatsink 30 while shielding the environment. In a preferred embodiment, filler 80 also has insulating properties and therefore insulates heatsink 30 from the surrounding environment.

In another embodiment, an area of space exists between the exterior edge of heatsink 30 and the interior surface 22 of sidewall 18, such that when filler 80 is poured into cavity 72, filler 80 extends between the exterior edge 64 of heatsink 30 and the interior surface 22 of sidewall 18 as well as filling the area below the bottom surface 34 of heatsink 30. In this embodiment, filler 80 maintains the lateral position of heatsink 30 relative to mug 10, as well as holding heatsink 30 into cavity 72. In addition, because of the thermal properties of filler 80, filler 80 assists to insulate heatsink 30 from the surrounding environment and helps to direct energy exchange between beverage area 28 and heatsink 30. In addition, because filler 30 is preferably at least partially compressible, filler 80 helps to take up some of the thermal expansion and contraction between heatsink 30 and mug 10 and therefore improves the functionality and longevity of mug 10.

Preferably filler 80 is clear such as a clear acrylic, clear plastic, a clear composite, a clear glass, a clear ceramic, or the like. Alternatively, filler 80 is any other material that flows into or can fit into cavity 72 and hold heatsink 30 in place, such as an opaque material or the like. Preferably, filler 80 expands after curing in cavity 72, or provides an outward force along arrow 82 so as to help hold heatsink 30 in place as well as keep a constant force on mug 10 and ensure or assist in a good seal or bonding to the interior surface 22 of cavity 72. This outward force along arrow 82 is a permanent and ever present once filler 80 is cured and exists whether the mug 10 is warmed, cooled, wet, dry, or under any other condition or temperature or in transition between temperatures or states. To help achieve these desired internal forces along arrow 82, when curing filler 80 a tempering process is used to help generate or maximize the desired internal forces of filler 80. As can be seen by arrow 82, filler 80 provides an outward force across the distance of cavity 72, thereby providing a force between opposing interior surfaces 22 of sidewall 18 thereby lockingly holding filler 80 and heatsink 30 in place. Filler 80 also provides a vertical force, along the vertical portion of arrow 82 thereby holding heatsink 30 into constant physical contact against bottom 12.

Alternatively, instead of using only one filler 80 or one layer of filler 80, a first layer of filler 80A is positioned between heatsink 30 and the bottom surface 16 of bottom 12 and the top surface 32 of heatsink 30. Once the first layer of filler 80A is installed, heatsink 30 is placed on top of first layer of filler 80A, or heatsink 30 is partially embedded within first layer of filler 80A, and then a second layer of filler 80B is installed thereby filling cavity 72. First layer of filler 80A and second layer of filler 80B engage one another at interface 80C at which point they bond to one another. Preferably, first layer of filler 80A and second layer of filler 80B extend partially over the side surface 64 of heatsink 30. First layer of filler 80A and second layer of filler 80B can be of the same material having the same properties or alternatively, first layer of filler 80A and second layer of filler 80B can be different materials having different properties. For instance, filler 80A can more easily exchange energy where as filer 80B can be more of an insulator thereby promoting energy exchange between beverage area 28 and heatsink 30 while shielding the surrounding environment. First layer of filler 80A and second layer of filler 80B can be of the same color and transparencies or different colors and transparencies. Alternatively, heatsink is levitated within a single layer of filler 80, without the use of two layers of filler 80,

In a preferred embodiment, filler 80 is sealed to interior surface 22 of cavity 72 so as to prevent any material, liquid or contaminants from entering between filler 80 and glass 10. This seal is achieved by way of mechanical forces, chemical induction, curing, sealers such as glue, epoxy, superglue or the like, special abraded surfaces 76 silicon or rubber seals, mechanical seals or the like. Preferably filler 80 mechanically and chemically bonds with the interior surface of cavity 72. Preferably, filler 80 fills cavity 72 to the transition point 78, such that filler 80 seals with the abraded surface 76 of the interior surface 22 of sidewall 18 up to the point where the interior surface 22 of sidewall 18 transitions back to a smooth or glass like surface. Preferably when filler 80 seals with the interior surface 22 of sidewall 18 a clear and transparent interface is achieved. That is, one can see through sidewall 18 and filler 80 despite the fact that the interior surface 22 of sidewall 18 may have an abraded surface 76.

In addition, a sealer 84 is placed at the interface of filler 80 and the interior surface 22 of sidewall 18 so as to help seal filler 80 to sidewall 18. Sealer 84 is any sealer known in the art such as glue, epoxy, superglue, caulk, silicon, rubber, welding, or the like. Preferably, sealer physically, mechanically and chemically bonds and/or infuses into both mug 10 and filler 80 thereby creating a permanent and impenetrable bond and seal preventing any liquid, or contaminates from entering the interface between filler 80 and mug 10. In a preferred embodiment, sealer 84 is a glue-like material that is compatible with both the material of mug 10 as well as the material of filler 10, or in a preferred embodiment a glue that is compatible with both glass and acrylic. Alternatively, the material of seal 84 is used across the entire interface of mug 10 and filler 80 thereby gluing or bonding or binding filler 80 to mug 10. The abraded surface 76 of cavity 72 further promotes and improves the ability of sealer 84 to bind filler 80 to mug 10.

In an alternative embodiment, with reference to FIG. 17, this embodiment is similar to that of FIG. 18. In this embodiment a lip 86 is part of sidewall 18 which extends inwardly into cavity 72 at or adjacent to bottom end 26 of sidewall 18. Lip 86 extends inwardly past the plane established by the interior surface 22 of sidewall 18. When filler 80 fills cavity 72, filler 80 engages lip 86, and in this way heatsink 30 is maintained within cavity 72.

In operation, a mug 10 is made having a cavity 72 located below bottom 12. The cavity groove 74 is either initially formed in the interior surface 22 of sidewall 18, or by way of a mechanical cutting or grinding process, cavity groove 74 is formed in the interior surface 22 of sidewall 18 after mug 10 is formed. Next a user abrades the desired interior surface of cavity 72 potentially including the bottom surface 16 of bottom 12, the interior surface 22 of sidewall 18 to transition point, and the surface of cavity groove 74. Next, a form fitted heatsink 30 is placed into cavity 72 with the heatsink top surface 32 in engagement with the bottom surface 16 of bottom 12, and the heatsink side surfaces 64 in frictional engagement with the interior surface 22 of sidewall 18, or at least within a close tolerance thereof. The user then pours filler 80 over the bottom surface 34 of heatsink 30 thereby filling the remaining space of cavity 72. Filler 80 flows and fills the remaining space of cavity 72 including flowing into cavity groove 74. The liquid filler 80 also fills the micro abrasions 76 wherever present should they be located on the interior surface 22 of sidewall 18, bottom surface 16 of bottom 12, within cavity groove 74, on the exterior surface of heatsink 30, or anywhere else within cavity 72. Preferably, filler 80 enters these micro abrasions 76 in mug 10 and creates a clear or transparent interface and seal thereto. The liquid filler 80 is then cured into a solid by way of exposure to time, air, heat, light, radiation or any combination thereof. The filler is also tempered so as to generate internal forces along arrow 82 which cause filler to exert a constant outward force on mug 10 including on the interior surface 22 of sidewall 18, bottom surface 16 of bottom 12, cavity groove 74 and even heatsink 30 thereby holding the entire assembly in firm, solid and locking condition. Once filler 80 has cured, or before it has cured, sealer 84 is provided around the interface of interior surface 22 of sidewall 18 and filler 80 thereby mechanically and chemically sealing this interface preventing any materials, chemicals or liquids from entering between filler 80 and mug 10.

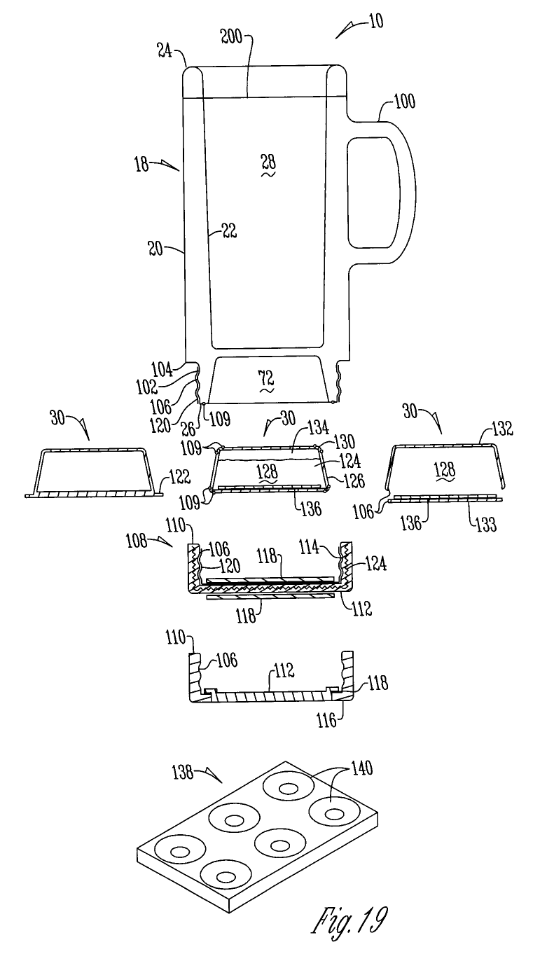

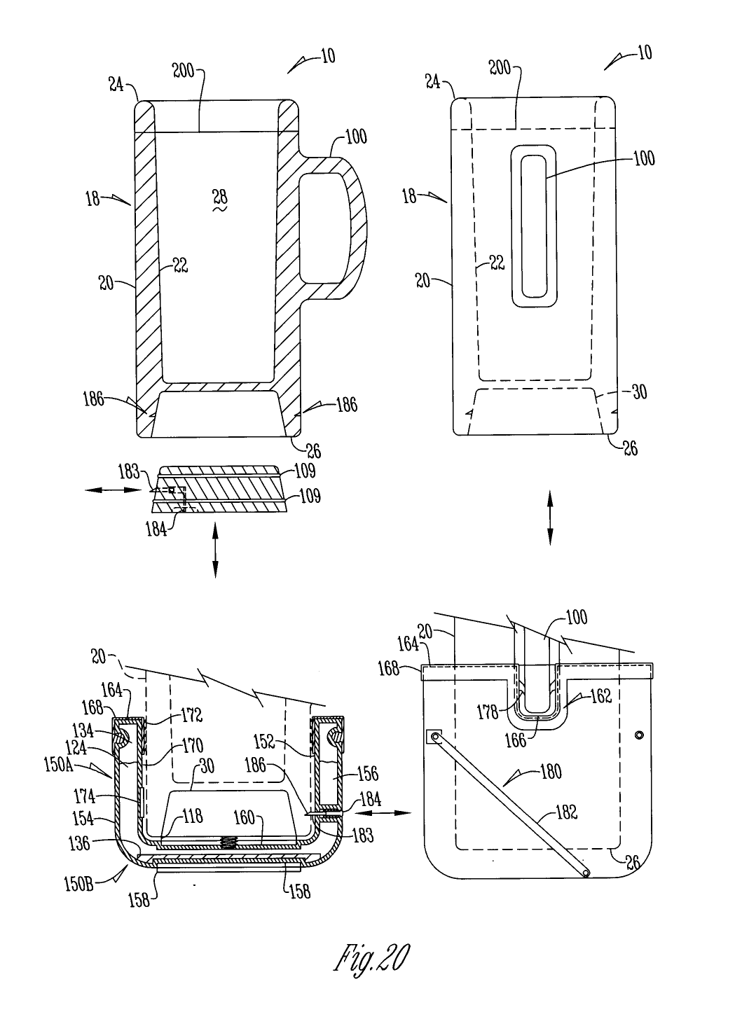

In an alternative embodiment, with reference to FIG. 19, a drinking mug 10 is presented having a recessed base, or cavity 72 and a handle 100 which protrudes outwardly from the exterior surface 20 of the sidewall 18. Preferably handle 100 extends outwardly from sidewall 18 spaced inwardly from both the top 24 and bottom end 26 of sidewall 18. This vertically inward spacing of handle 100 allows for easy use and gripping by a consumer and good balance. It also prevents handle 100 from interfering with a user's face when drinking as well as preventing interference with the surface upon which mug 10 rests when not in use. The size and shape of the mug 10 and handle 100 is exemplary and is not meant to be limiting. Alternatively, handle 100 is not present on the mug 10, and in this arrangement the mug 10 can have vertical sidewalls 18 or alternatively angled sidewalls 18 like a commonly known pint glass.

In this embodiment, sidewall 18 extends downwardly past bottom 12 thereby defining a beverage area 28 above the top surface 14 of bottom 12, and a cavity 72 below the bottom surface 16 of bottom 12. That is, the bottom end 26 of sidewall 18 extends past and below bottom 12 thereby defining cavity 72. Cavity 72 is bounded at its top by bottom surface 16 of bottom 12, and at its sides by the interior surface 22 of sidewall 18. Cavity 72 is of any size and shape which functions to hold heatsink 30. Cavity 72 can also extend upwardly within the sidewall 18, between the interior surface 22 and the exterior surface 20 and above either the bottom surface 16 of the bottom 12, or above the top surface 16 of bottom 12, as is described herein.

In one embodiment, the interior surface 22 of sidewall 18 angles inwardly as it extends upwardly towards bottom surface 16 of bottom 12 thereby producing a trapezoidal-shaped cavity 72 when viewed from the side. This shape is similar to the design of the cavity 72 in the base of a Libbey 5018 14 Ounce Paneled Mug. This inward angle to the interior surface 22 of sidewall 18 within cavity 72 allows for easy molding of mug 10, as well as easy insertion and removal of heatsink 30. Alternatively the interior surface 22 of sidewall 18 extends vertically thereby producing a square or rectangular shaped cavity 72 when viewed from the side or any other shape is contemplated.

Extending upwardly from the bottom end 26 of sidewall 18 is inwardly spaced plane 102. Inwardly space plane 102 extends vertically or in parallel spaced relation to the exterior surface 20 of mug 10, and is preferably spaced between the plane of interior surface 22 and exterior surface 20 of sidewall 18 adjacent beverage area 28. Inwardly spaced plane 102 extends upwardly until it terminates at step 104. At step 104 the inwardly space plane 102 transitions to the diameter or plane of the exterior surface 20 of sidewall 18. Inwardly spaced plane 102 extends between step 104 and the bottom end 26 of sidewall 18. Inwardly spaced plane 102 has a narrower diameter than the exterior surface 20 of sidewall 18 adjacent the beverage area 28. Alternatively, inwardly spaced plane 102 is flush with or extends past the exterior surface 20 or sidewall 18. Inwardly spaced plane 102 defines a narrower diameter to the mug 10, as compared to sidewall 18 above the inward step 104. Preferably, inwardly spaced plane 102 extends a portion of the height of cavity 72 and step 104 is positioned below the bottom surface 16 of bottom 12. Alternatively, inwardly spaced plane 102 extends the entire height of cavity 72 and step 104 is aligned with the bottom surface 16 of bottom 12. Alternatively, inwardly spaced plane 102 extends above the height of cavity 72 and step 104 is either positioned between the bottom surface 16 and the top surface 14 of bottom 12, or step 104 is positioned above the top surface 14 of bottom 12. Threads 106 are positioned on the outside surface of inwardly spaced plane 102. Alternatively, step 104 is not present and inwardly spaced plane is flush with the exterior surface 20 of sidewall 18 adjacent its bottom end 26. Alternatively, step 104 extends outwardly from sidewall 18. Preferably, inwardly spaced plane 102 is round, when viewed from the bottom, and extends straight, square or perpendicular when viewed from the side which allows for easy attachment of lid 108 by way of rotatably screwing thereon. The features of the inwardly spaced plane 102, step 104 and threads 108 are formed directly in the mug 10 when the mug is made. Alternatively inwardly spaced plane 102, step 104 and threads 108 are cut into the mug 10 after the mug is made.

Also, positioned at the bottom end 26 of sidewall 18 is a compressible O-ring 109. Preferably, O-ring 109 fits within a groove in the bottom end 26 of sidewall 18 and is held in place with an adhesive material. In this arrangement, O-Ring 109 preferably has a circular or round side view. Alternatively, O-ring 109 is disk shaped and has a flat side view. In this arrangement disk-shaped O-ring 109 is flushly attached to the bottom end 26 of sidewall 18 preferably by adhesive. O-ring 109 is made of any compressible material such as foam, rubber, plastic, urethane, acrylic, composite, or any other compressible material.

Lid 108 is removably, replaceably and matingly received by inwardly spaced plane 102, step 104 and threads 106. Lid 108 is either made of a single piece design, or alternatively a two piece design having a threaded ring 110 and a bottom plate 112. Threaded ring 110 has threads 106 on its inwardly facing surface 114 and is sized and shaped to fit over inwardly spaced plane 102 with the threads of threaded ring 110 and inwardly spaced plane 102 in threadably meshing engagement. The bottom edge of threaded ring 110 has lip 116 which extends inwardly towards the center of the mug. In the two piece design, lip 116 engages and holds bottom plate 112. Connected to the bottom surface of the lid 108, or the bottom plate 112, is a compressible disk 118 which prevents mug 10 from sliding when placed on a surface when not in use. Compressible disk 118 also helps reduce shock when mug 10 is slammed on a table or bar top and helps to protect the surfaces upon which mug 10 is placed by preventing scratching and preventing sweating. Compressible disk 118 is made of any material that is compressible, prevents slippage, prevents sweating, and is somewhat malleable such as plastic, rubber, composite, fiberglass, urethane, acrylic, UHMW material or any other material that improves the mugs function. Similarly, a compressible disk 118 is positioned on the inside surface, or top surface of lid 108, or the bottom plate 112 to absorb shock from mug 10, absorb dimensional variances between mugs 10, and to help hold lid 108 in place on mug 10 by allowing for compression.

Especially if mug 10 is made of glass and lid 108 is made of metal or another hard material a compressible protective coating 120 is placed on or over threads 106 of lid 108 or on the entire interior surface of lid 108. Alternatively, this compressible protective coating 120 is placed on threads 106 of the inwardly spaced plane 102, or alternatively the entire inwardly spaced plane 102. This compressible protective coating 120 protects the threads 106 and the lid 108 and inwardly spaced plane 102 from damaging one another (such as scratching or chipping), it holds the meshing engagement of threads 106 with one another when lid 108 is screwed on mug 10, and provides a water tight seal between lid 108 and mug 10. Compressible protective coating 120 is any material that can protect and seal the lid 108 and mug 10 as well as help hold them together by being compressible such as plastic, rubber, composite, fiberglass, urethane, acrylic, UHMW material or any other material that helps to protect and hold.

Preferably lid 108 is made of a metallic material such as steel, iron, aluminum or any other alloy or metal with a single wall design. Alternatively, lid 108 is made of any other material such as plastic, rubber, composite, fiberglass, urethane, acrylic, UHMW material or any other nonmetallic material. Alternatively, lid 108 has a dual-wall design, as is described herein.

In the two-piece design, bottom plate 112 is made of any of the materials described herein. Alternatively, so as to allow a user to view through bottom plate 112 and into cavity 72, bottom plate 112 is made of a transparent material such as glass, vinyl, plastic, Plexiglas or any other transparent material. Alternatively, plate 112 is not used and instead lid 108 directly engages heatsink 30 around the heatsink's bottom outside edges or a lip 122 which extends outwardly from the bottom 34 of the heatsink 30, thereby holding heatsink 30 in place.

Removably, replaceably and matingly received by and within cavity 72 is heatsink 30, as is described herein. That is, heatsink 30, can be a solid piece of metal such as lead, steel, aluminum etc. as is described above. Alternatively, heatsink 30 is a mass of phase change material (PCM), gel, thermal gel (TG), water, or any other material that has beneficial thermal properties, hereinafter heat material 124.

For purposes of further description, gel, thermal gel, or refrigerant gel is preferably a non-toxic liquid, solid or gel-like substance that can absorb a considerable amount of heat, since it has a high enthalpy of fusion. The enthalpy of fusion, also known as the heat of fusion or specific melting heat, is the change in enthalpy resulting from the addition or removal of heat from 1 mole of a substance to change its state from a solid to a liquid (melting) or the reverse processes of freezing. It is also called the latent heat of fusion, and the temperature at which it occurs is called the melting point. When thermal energy is withdrawn from a liquid or solid, the temperature falls. When thermal energy is added to a liquid or solid, the temperature rises. However, at the transition point between solid and liquid (the melting point), extra energy is required (the heat of fusion). Similarly, a phase change material (PCM) is a substance with a high heat of fusion which, when melting and solidifying at a certain temperature, is capable of storing and releasing large amounts of energy. Heat is absorbed or released when the material changes from solid to liquid and vice versa; thus, PCMs are classified as latent heat storage (LHS) units and can be made from made from high-technology processed fats and oils, they can be organic, such as Paraffin (CₙH₂ₙ₊₂) and Fatty acids (CH₃(CH₂)₂ₙCOOH), or inorganic, such as Salt hydrates (MₙH₂O).

Merely as examples, these materials include Koolit® manufactured by Cold Chain Technologies, 29 Everett Street, Holliston, Mass. 01746, Cold Ice® made by Cold Ice, Inc. 9999 San Leandro Street, Oakland, Calif. U.S.A. 94603; Techni Ice™ made by Techni-ICE Dry Ice Packs, 1021 Woodoak Conn., Fort Worth, Tex. 76112; RPCM manufactured by Glacier Tek Inc., PO Box 120642, West Melbourne, Fla. 32912 USA; savEnrg™ Phase Change Materials manufactured by Energy Efficient Systems, 1465 Sand Hill Road, Suite #171, Candler, N.C.-28715 or any one of a vast number of other materials. Preferably heat material 124 is in a liquid or gel state at room temperature and freezes to a solid when chilled, preferably but not necessarily below 32 degrees Fahrenheit.

Preferably heat material 124 is encapsulated by the sidewall 126 of heatsink 30 which defines an open interior 128 of heatsink 30. In this arrangement, sidewall 126 is preferably made of a hard and durable material such as stainless steel, copper, aluminum, or any other metal or alloy, or a non-metallic durable material such as plastic, rubber, composite, fiberglass, urethane, acrylic, UHMW material or any other nonmetallic material. To encapsulate the heat material, sidewall 126 is welded or glued to itself along a seam or corner 130 to form a heatsink 30 which contains heat material 124 which is permanently encapsulated. Alternatively, heatsink sidewall 126 comprises of at least two pieces, such as a main body 132 and a top 133 which are removably and replaceably connected to one another such as by a snap fit design, threads 106, or any other connection member or method. In one arrangement, heatsink sidewall 126 is formed like a soda can, that is pressing a first piece, or main body 132, having a hollow interior and welding or crimping on a top 133 thereby enclosing a quantity of soda within the soda can. In any arrangement, heatsink 30 preferably has a smooth and sleek surface so as to reduce the potential for biological contamination of heatsink 30. In addition, heatsink 30 is preferably dishwasher safe so as to allow easy cleaning.

Heatsink 30 can take on any shape that fits within cavity 72. Typical shapes include straight cylindrical shape, or a tapered cone that terminates before the point. Heatsink 30 can also include a heatsink lip 122 which extends outwardly from the heatsink side surface 64 preferably at the bottom of the heatsink 30. This lip 122 engages lid 108 or threaded ring 110 to hold heatsink 30 within cavity 72. Also, to prevent breaking or cracking of the mug 10, all corners of the heatsink 30 are rounded or chamfered so as to prevent any sharp points from engaging mug 10.

Positioned within the open interior 128 of heatsink 30, along with a quantity of heat material 124, is an amount of compressible gas 134 such as air, an inert noble gas, a noble gas mixture or any other compressible gas. This quantity of compressible gas 134 acts as a cushion to absorb thermal expansion or contraction from the heat material 124 when it freezes or thaws. Alternatively or in addition to the compressible gas 134 a compressible material 136 such as rubber foam or the like material is positioned within the open interior 128 of heatsink 30 to likewise absorb the thermal expansion and retraction of the heat material 124 when freezing or thawing. Compressible material 136 is preferably positioned on the inside of the bottom of the open interior 128 of heatsink 30. By placing compressible material 136 on the bottom of the open interior this forces the heat material 124 towards the top of the open interior 128 which enhances the thermal exchange of energy between the beverage area 28 and the heat material 124. In addition by locating compressible material 136 on the bottom of heatsink 30 compressible material acts to insulate the bottom of heatsink 30 and mug 10. Compressible material 136 provides a benefit over using compressible gas 134 because compressible gas 134 will migrate toward the top side of the open interior 128 of heatsink, thereby placing the compressible gas 134 between the beverage area 28 and the heat material 124 thereby reducing the heat material's cooling effect. For this reason the compressible gas 134 can be placed in a balloon, closed cell foam, or container adjacent the bottom of the open interior 128 of heatsink 30.

Also, positioned on the top side, bottom side and outside edges, or otherwise where needed, are compressible O-ring 109 as described above. If an O-ring is positioned on the top side or outside surface of heatsink 30, and can reside partially within a recess or groove this O-ring helps to cushion the engagement between the cavity 72 of mug 10 and heatsink 30. In addition, these O-rings 109 also help to absorb some of the dimensional differences between mug 10 and heatsink 30, as well as to absorb the thermal expansion and contraction of heatsink 30. Alternatively any compressible material such as a compressible pad can replace O-ring 109. The O-ring 109 can reside within a groove on the surface of heatsink 30 to hold it in place.

In operation, a heatsink 30 containing heat material 124 is formed by placing a quantity of heat material 124 within the open interior 128 of main body 132 while leaving enough room for a sufficient quantity of compressible gas 134 within open interior 128 to absorb the thermal expansion of heat material 124 without heatsink 30 exploding or imploding. Alternatively or in addition the compressible material 136 is also positioned on the inside of the bottom of the open interior 128. Next top 133 is connected to main body 132 by any means known in the art such as gluing, molding, welding, crimping, forming, etc if the heatsink 30 is permanently encapsulated. Once formed the surface of the heatsink 30 can be given a surface treatment to improve its aesthetic appearance or to improve its ability to resist contamination such as a plating layer (perhaps stainless steel) or powder coating, anodization or marketing logos or designs. Or otherwise, if the main body 132 and top 133 are removably and replaceably connected, top 133 is screwed, crimped, or snapped onto the main body 132 in a removable manner.

Once formed, heatsink 30 is positioned within cavity 72 of mug 10. Preferably heatsink 30 is matingly received within cavity 72 such that when fully inserted heatsink top surface 32 flushly engages the bottom surface 16 of bottom 12, and heatsink side surface 64 flushly engages the interior surface 22 of sidewall 18. In this position, the heatsink bottom surface 34 either lies flush with the bottom end 26 of mug 10, or it terminates slightly within or fully within cavity 72, or extends past the bottom end 26 of mug 10. If O-rings 109 are present on the surface of heatsink 30, the O-rings 109 engage both the surface of the heatsink 30 and the surface of cavity 72 of mug 10 and slightly compress thereby absorbing some of the dimensional differences between heatsink 30 and cavity 72 as well thermal expansion and contraction differences. If heatsink 30 has a lip 131, when fully inserted heatsink lip 131 engages the bottom edge 26 of sidewall 18. In this position, preferably a compressible material is positioned between heatsink lip 131 and bottom edge 26 of sidewall 18 so as to absorb some of the shock between heatsink 30 and sidewall 18 such as when mug 10 is slammed on a table. This compressible material, such as O-ring 109 also helps absorb some of the dimensional variability between heatsink 30 and cavity 72 as well as thermal expansion and contraction of the mug 10 and heatsink 30.

Once heatsink 30 is fully inserted within cavity 72, lid 108 is placed over bottom edge 26 of mug 10 to hold heatsink 30 within cavity 72. In this arrangement lid 108 is screwed over inwardly spaced plane 102 such that the threads 106 of the inwardly facing surface 114 of lid 108 or threaded ring 110 meshingly and threadably engage threads 106 of inwardly spaced plane 102. In this position the protective coating 120 over threads 106 helps to both protect the lid 108 and mug 10 as well as to lock the lid 108 and mug 10 together thereby preventing unintentional loosening of lid 108 and mug 10 as well as providing a watertight seal there between. Once fully screwed onto the mug 10, the top edge of lid 108 engages step 104 thereby stopping the continued rotation or tightening of lid 108 onto mug 10. In this position if lid 108 is paneled and mug 10 is paneled the arrangement of the threads 106 and the step 104 act to align the panels for an aesthetically pleasing look. Also, in this position the outside edge of lid 108 is preferably flush with the outside surface 20 of sidewall 18. Alternatively the lids outside surface can be recessed or extend beyond the exterior surface 20 of sidewall 18.

In this position if the lid 108 is a single piece design, the top side of bottom plate 112 engages the bottom surface 34 of heatsink 30 thereby holding it in place. Preferably compressible disk 118 is positioned between the top side of bottom plate 112 and bottom surface 34 of heatsink 30. Compressible disk 118 helps to absorb shock between the mug 10 and heatsink 30 when the mug 10 is slammed on a table. In addition, compressible disk 118 absorbs dimensional variances between mug 10 and heatsink 30 as well as the thermal expansion and contraction of the heatsink 30 and mug 10 when freezing and thawing. This cushion or give provided by compressible disk 118 also helps to lock the lid 108 and mug 10 together thereby preventing unintentional loosening of lid 108 and mug 10.

Alternatively if a lid 108 is used that is a two piece design, the bottom plate 112 is positioned within the threaded ring 110 prior to tightening the threaded ring 110 onto inwardly spaced plane 102. In this position lip 116 of threaded ring engages the bottom plate 112 thereby holding it in place.

Alternatively if only threaded ring 110 is used, the lip 116 of threaded ring 110 engages the bottom outside edge of heatsink 30 directly thereby holding heatsink 30 within cavity 72. Alternatively, a compressible material is positioned between lip 116 and heatsink 30 for the above described purposes of absorbing dimensional variability and thermal expansion and contraction.

Once fully assembled, mug assembly 10 is inserted in a refrigerator or a freezer. The mug assembly 10 is allowed to attain the equilibrium temperature of the freezer. Preferably, the heat material 124 encapsulated within sidewall 126 of heatsink 30 changes phases from liquid to a solid (or alternatively from a solid to a liquid) as the mug assembly cools and reaches equilibrium temperature of the freezer. As this freezing of the heat material 124 occurs, if it expands or contracts, the compressible gas 134 absorbs or expands to accommodate the volumetric difference within the interior 128 of heatsink 30. Alternatively or in addition, compressible material 136 similarly expands or contracts.

Once the mug assembly 10 reaches the temperature of the freezer, the mug assembly 10 is removed from the freezer and a beverage is poured within the beverage area 28 of the mug 10. As described above, the chilled material of mug 10 helps to keep the beverage cooler for longer. In addition, the heat material 124 within the heatsink also helps to keep the beverage cooler for longer because of its beneficial thermal properties. In addition, as the heat material 124 approaches its melting point (or freezing point) it requires or absorbs additional energy to change phases, which also helps to keep the beverage cool. This is because the heat material 124 draws more energy out of the beverage to change (or melt) between a solid and a liquid (or vice versa to freeze). Also, to help maintain the beverage a cool temperature for a longer period of time, insulation is provided on the bottom side of heatsink 30 such as between heatsink 30 and bottom plate 112, and/or the lid 108 (including the portion of lid 108 which extends up the sidewall 18 of mug 10) is made of an insulating material or has an insulating layer.

Alternatively, instead of chilling all components of the mug assembly 10 in the freezer in an assembled state, each part, or some of the parts such as only the heatsink 30 or the heatsink 30 and the mug 10, are chilled in the freezer in an unassembled state. Then, once each component reaches the equilibrium temperature of the freezer, the component parts are removed and the mug assembly is assembled.

Due to the placement of the compressible components, such as O-rings 109, compressible disk 118, protective coating 120 between the mug 10 and the lid 108, or between the heatsink 30 and lid 108, or between the heatsink 30 and mug 10, one benefit of this design is, when the lid 108 is tightened upon mug 10, these compressible components compress and create a watertight seal between the component parts. This allows a user to get the mug assembly 10 wet, or wash the mug 10 without any water working its way between the mug 10 and lid 108 or heatsink 30. This water-tight sealing feature reduces the potential for bacteria and other contamination from working its way between these parts. This reduces the frequency of required cleanings. This also allows the user to wash the mug assembly as a single piece, or by breaking it apart. To clean the mug assembly 10 by washing each part individually, the lid 108 is unscrewed from mug 10. Next, the heatsink 30 is removed from cavity 72. All components are placed in the washer and washed. Alternatively they are washed by hand.

Alternatively, instead of using a pre-manufactured or purchased heatsink 30, the user inverts the mug assembly 10 and pours water into the cavity 72. Once the cavity 72 is filled with water the user places the inverted mug 10 into the freezer. When the mug 10 cools to the ambient temperature of the freezer the water freezes thereby forming a heatsink 30 that is made completely of water. As water expands roughly 9% when it freezes, preferably the user does not completely fill the cavity 72 and instead leaves roughly 9% or more space unfilled in cavity 72. To deal with this expansion of the water within cavity 72, the cavity 72 preferably has walls that angle or curve towards the center of the mug 10 as they extend upwardly from bottom end 26 to the bottom surface 16 of bottom 12. The inward and upward angle and/or curve of the interior sidewall of cavity 72 is proportionate to the amount of expansion of the frozen water. This inward and upward angle or curve of the interior sidewall of cavity 72 causes the water within cavity 72 to expand towards bottom end 26 (or upwardly when the mug 10 is inverted) instead of merely expanding outwardly. When the water freezes it may shift, pop or release from contact with the bottom surface 16 of bottom 12 thereby leaving a space between the top surface 32 of heatsink 30 and the bottom surface 16 of bottom 12. Alternatively the water expands towards bottom end 26. This upward expansion of the water within cavity 72 as it freezes prevents the water from cracking, breaking or shattering the mug 10. To help absorb some of the expansion of the freezing water, a compressible layer or object, as is described herein can line the cavity 72 or be placed within cavity 72 to prevent breaking the mug.

Once the mug 10 and the water within cavity 72 freeze or reach the ambient temperature of the freezer, the user removes them from the freezer. The user then places lid 108 over the bottom end 26 of sidewall 18 and tightens it on mug 10. As the user tightens the lid 108 on mug 10, the compressible portions of the mug assembly 10 form a watertight seal between the lid 108 and mug 10 which prevents the water heatsink 30 from leaking once it begins to melt. These compressible portions include compressible o-ring 109, compressible disk 118 and protective coating 120 positioned between lid 108 and mug 10. The same can be said for other materials which expand when they freeze such as PCM or thermal gel.

Alternatively, lid 108 is designed to absorb or handle the expansion of the freezing water such as having an expandable panel such as made out of rubber or plastic. Alternatively, an air gap is left between the lid 108 and the top of the water. Alternatively the lid has a compressible material 134 thereon which helps to absorb this thermal expansion.

Alternatively, instead pouring water into the cavity 72 and freezing it to form heatsink 30, the heatsink 30 is formed outside of cavity 72 and is then placed into cavity 72 prior to use. In this arrangement, a user takes tray 138, which has at least one, and preferably a plurality of tray cavities 140 therein which are sized and shaped to produce frozen water heatsinks 30 which fit within cavity 72. To create heatsinks 30 which fit within cavity 72, tray cavities 140 must be sized and shaped to accommodate the expansion of water as it freezes.

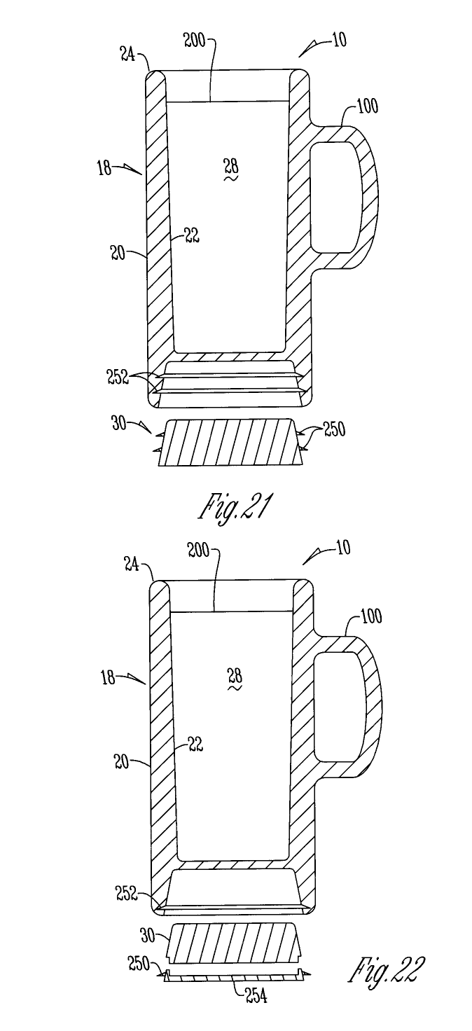

In an alternative embodiment, with reference to FIG. 20, a shield 150 is presented which is sized and shaped to removably, replaceably and matingly receive mug 10. Preferably shield 150 is sized and shaped to receive standard drinking mugs, glasses, or pint glasses as is known in the art. Shield 150 preferably has a vertical sidewall 150A and a horizontal bottom 150B which meet at a 90 degree angle, which is preferably smoothed, curved or chamfered. Shield 150 is made of at least a single wall design, if not a double wall design, triple wall design, quadruple wall design or any number of walls. Shield 150 is made of an insulating material such as aluminum, steel, titanium, alloy, fiberglass, foam, plastic, UHMW, composite, or any other insulating material, or combination or layers of materials. While it is hereby contemplated that shield 150 is made of a single layer or wall of homogenous material, pictured in FIG. 20 is a shield 150 having a first inner wall 152 and a first outer wall 154. Inner wall 152 and outer wall 154 extend in parallel spaced relation thereby defining an interior space 156 between the walls 152, 154. Interior space 156 is either under vacuum, meaning there is very little gas between the sidewalls 152, 154, or at least gas under a pressure less than the external atmosphere, which provides an insulating effect by reducing the ease or ability of energy to transfer across the vacuum. Alternatively, interior space 156 is filled with an insulating material, as described above, such as foam, fiberglass, plastic, Styrofoam, a gas such as air, a noble gas, or any other insulating material. Alternatively, interior space 156 of shield 150 is filled with a heat material 124 such as PCM, gel or thermal gel as is described herein in relation to encapsulated heatsink 30 of FIG. 19. This includes the use of a compressible material 136 and a compressible gas 134 within interior space 156 of shield 150.

The bottom 150B of shield 150 extends across the bottom 12 of mug 10 and the sidewall 150A of shield 150 extends across at least a portion of sidewall 18, extending upwardly from bottom end 26 and terminating before top end 24. Alternatively, shield 150 does not extend across the bottom 12 of mug 10 and instead only extends upwardly from bottom end 26 of sidewall 18 of mug 10.

Connected to the exterior bottom surface of the bottom 150B of shield 150 is a compressible disk 118 which prevents mug 10 and shield 150 from sliding when placed on a surface when not in use. Compressible disk 118 also helps reduce shock when mug 10 and shield 150 are slammed on a table or bar top and helps to protect the surfaces upon which mug 10 is placed by preventing scratching and preventing sweating. Compressible disk 118 is made of any material that is compressible, prevents slippage, prevents sweating, and is somewhat malleable such as plastic, rubber, composite, fiberglass, urethane, acrylic, UHMW material or any other material that improves the mugs function as is described herein. Similarly, a compressible disk 118 is positioned on the inside surface, or top surface of bottom 150B of shield 150, adjacent bottom end 26 or bottom 12 of mug 10 to absorb shock from mug 10 when slammed, absorb dimensional variances between mugs 10, and to help insulate mug 10. Compressible disk 118 can be of any effective size and shape such as a round O-ring, a flat O-Ring, a disk that completely or partially covers the entire bottom or top surface area of the bottom of shield 150, or a plurality of compressible feet spaced across the bottom 150B. Alternatively, compressible disk 118 can extend partially up or all the way up the inner wall 152 and outer wall 154 of shield 150 to help insulate shield 150, to help grasping of the shield by a user, to help the shield 150 grasp the mug 10, or to absorb dimensional variances between shield 150 and mug 10. Alternatively or additionally, shield 150 is coated on its inside or on its outside by a protective and/or insulating layer or a plurality of layers as is described herein such as paint, clear coat, plastic, composite or the like. Compressible disk 118 is attached flushly to the flat bottom surface of shield 150 or preferably, compressible disk 118 is positioned within a bottom recess 158 in the bottom of shield 150 which is sized and shaped to fit compressible disk 118. Compressible disk 118 is attached flushly to the flat top surface of shield 150 or preferably, compressible disk 118 is positioned within a top recess 160 in the top of shield 150 which is sized and shaped to fit compressible disk 118.

To removably, replaceably and matingly receive a mug 10 having a handle 100 shield 150 has a slot 162 within its vertical sidewall 150A. Slot 162 allows the top edge 164 of the sidewall of shield 150 to slide around and past handle 100. Slot 162 extends from top edge 164 downwardly until it terminates at slot bottom 166. Slot 162 is sized and shaped to frictionally engage or barely fit around handle 100 so that shield 150 covers as much of the surface area of sidewall 18 of mug 10 as possible so as to provide the greatest amount of insulation to mug 10. When fully engaged over mug 10, slot bottom 166 engages or is adjacent the bottom of handle 100 thereby preventing further upward movement of shield 150 over mug. 10. Also, in this position preferably bottom end 26 of mug 10 engages the top surface of the bottom of shield 150, or alternatively, the bottom end 26 of mug 10 engages the compressible disk 118 positioned on the top surface of the bottom of shield 150.

Positioned around the top edge 164 of shield 150 is seal 168. Preferably seal 168 also extends around the entire slot 162 and slot bottom 166. Seal 168 is made of any malleable or compressible material, as is described herein, such as rubber, plastic, composite or any other like material. Seal 168 extends inwardly from top edge 164 and slot 162 towards the sidewall 18 of mug 10. The inside diameter of this inward extension of seal 168 is smaller than the diameter, and/or shape, of the outer diameter of mug 10 so as to ensure a frictional engagement, a snug-fit, and a seal there between. This inward extension provides a malleable and compressible connection to the exterior surface 20 of sidewall 18 all the way around the top edge 164 and along the entire slot 162 and the slot bottom 166 of shield 150. This frictional engagement prevents liquid or condensation from working its way between shield 150 and mug 10. This also prevents any liquid that is between shield 150 and mug 10 from pouring out onto the user when they tip the mug assembly 10 back to take a drink. This inward extension of seal 168 helps to center mug 10 within shield 150 and frictionally hold or attach shield 150 to mug 10. In addition, inward extension of seal 168 also positions the inner sidewall 152 of shield 150 a set distance away from the exterior surface 20 of sidewall 18 of mug 10. The seal 168 isolates the air within this space or gap 170 between the shield 150 and mug 10. By isolating the air within gap 170 and preventing it from intermixing with air from the environment, sealing this air within gap 170 also helps to insulate mug 10. Also, the frictional engagement between seal 168 and mug 10 helps to hold mug 10 and shield together when in use, yet allows the user to remove the shield 15 and mug 10 when desired. This arrangement also helps to prevent condensation around the mug 10 when in use. Preferably the frictional force of the seal 168 on mug 10 is greater than the force of gravity on shield 150 such that the mug 10 is held by handle 100. The shield 150 hold itself onto mug 10. The shield 150 is only removed when the user applies enough force to overcome the frictional force.

Seal 168 also extends down a portion of the inner wall 152 and outer wall 154 of shield 150. The downward extension of seal 168 along the outer wall 154 helps to prevent a user's lips from contacting the sidewall 150A of shield 150, which is especially important when shield 150 is made of a metallic material that is cold. In addition, the added downward extension of seal 168 along the inner wall 152 adds to the ability of seal 168 to seal to sidewall 18 of mug 10. This also provides enough surface area for several inward extensions, such as a plurality of flanges 172 which engage the sidewall 18 of mug 10. Preferably three flanges 172 are present, however two, four, five or any number of flanges are contemplated. This provides a plurality or redundancy of layers of seals thereby improving the sealing ability of seal 168. Seal 168 is connected to shield 150 by any means known in the art such as through frictional engagement, adhesive, non-removeably forming a portion of the seal 168 into a portion of the shield 168, non-removeably forming a portion of the seal 168 into a plurality of holes or orifices in shield 150, forming a portion of the seal 168 within a groove in the shield 168, providing a snap-fit arrangement between shield 168 and seal 168 or any other means known in the art.

Positioned on the inner wall 152 of shield 150 is a plurality of ribs 174. Ribs 174 are similarly made of a malleable material as described above. Ribs 174 similarly extend inwardly to connect to the exterior surface 20 of sidewall 18 of mug 10. Ribs 174 help to hold shield 150 to mug 10 as well as improve the rigidity of the assembly by increasing the surface area where shield 150 connects to mug 10. Ribs 174 connect to or are an extension of seal 168. Alternatively, ribs 174 stand alone and are only connected to the inner wall 152 of shield 150.

Shield 150 also has a locking mechanism 176 which acts to hold or lock shield 150 onto mug 10. Preferably, locking mechanism 176 is a snap-fit frictional engagement mechanism which receives the top or bottom horizontal stem portion of handle 100 adjacent to where it connects to mug 10 within slot 162 either adjacent to slot bottom 166 or the top of the slot 162, or both. In this arrangement, locking mechanism 176 has a pair of opposing locking members 178 which extend inwardly at an angle from seal 168 and across slot 162 from one another adjacent one another. These locking members 178 are partially malleable, compressible, bendable or resilient and are spaced apart and sized so as to frictionally engage and strongly hold the stem of handle 100 when mug 10 is pushed downwardly within shield 150. That is, as mug 10 is pushed downwardly within shield 150, handle slides downwardly within slot 162. When mug 10 is almost fully inserted within shield 150 and slot 162, the stem (or horizontal portion) of handle 100 engages the opposing and inwardly extending locking members 178 thereby stopping the insertion of mug 10 within shield 150. If a greater amount of force is applied to bend or overcome the frictional engagement of locking members 178 on the stem of handle 100, mug 10 then slides past the locking members 178 to a fully inserted point wherein the locking members 178 now hold mug 10 within shield 150. Locking members 178 can be made of the same material as seal 168, or a different, more or less malleable material. While a locking mechanism 176 which connects to the handle is described herein, any other locking mechanism 176, or mechanism which snaps onto, frictionally engages, or mates with a portion of mug 10 is herein contemplated, such as the seal 168 or an inward extension of seal 168 snapping into a groove, ring or deviation in the sidewall 18 of mug 10, or any other arrangement. As an example, when using shield 150 with a handle-less glass, such as a traditional pint glass, intermeshing threads 106 on the bottom interior of shield 150 and an inwardly spaced plane 102 can be used to lock the shield 150 and the pint glass together (as the pint glass does not have a protruding handle, rotating the shield 150 on the pint glass is possible). This arrangement is similar to swapping out the lid 108 of the prior embodiment (FIG. 19) for the shield 150 described in this embodiment having threads 106 thereon (FIG. 20).

Shield 150 also has a connection member 180 which is any mechanical member which connects and holds shield 150 to mug 10, such as a strap and button 182 which extends from one side of the slot 162 to connect to the other side of the slot 162 over, under or around handle 100. Connection member 180, could also be a spring loaded pin 183 and actuator 184 arrangement wherein pin 183 fits within a recess, deviation or pin hole 186 in sidewall 18 of mug 10. That is, when mug 10 is positioned within shield 150, spring loaded pin 183 is forced to slide along the exterior surface 20 of sidewall 18 of mug 10, until the mug 10 is almost fully engaged within shield 150. At this point, spring loaded pin 183 comes into alignment with pin hole 186 and the bias of spring loaded pin 183 forces the pin 183 within pin hole 186 thereby locking shield 150 onto mug 10. When the shield 150 is to be removed, the actuator 184, or button is depressed, which overcomes the forward bias of pin 183 thereby withdrawing spring loaded pin 183 from pin hole 186. This allows the shield 150 and mug to be separated.

Similarly, the heatsink 30 is connected to cavity 72 using a connection member 180, spring-loaded pin 183 and actuator 184. That is, heatsink 30 has a spring loaded pin 183 which extends outwardly from the sidewall of heatsink 30. The pin 183 fits within a pin hole 186 on the interior surface of cavity 72 so as to hold heatsink within cavity 72. A spring or other biasing member resides within the heatsink 30. When the heatsink 30 is to be removed from cavity 72, the user actuates actuator 184 protruding from the bottom of heatsink 30, which withdraws pin 183 from pin hole 186. Two, three or more pins 183 and pinholes 186 may be necessary in heatsink 30 to hold heatsink 30 within cavity 72. In addition, one or more non-retractable pins 183, protrusion or feet which are received within corresponding pinholes 186 may be used opposite or across from the retractable pin 183 so as to provide a pivot point or added point of engagement to hold heatsink 30 within shield 150.

So as to prevent condensation and contamination from coming between the mug 10 and heat sink 30 in this arrangement, an o-ring 109 is preferably stretched around heatsink 30 near the bottom of its sidewall. The o-ring 109 is preferably resides within a groove in the heatsink 30. When heatsink 30 is in position within cavity 72 o-ring 109 engages the mug 10 thereby sealing heatsink 30 to mug 10 which is locked in place by pin 183. Preferably o-ring 109 is received within a groove in the wall of cavity 72 when in place to further improve the seal and help hold heatsink 30 into recess 72.

The use of a shield 150 does not inhibit the use of a heatsink 30. In this arrangement, the heatsink 30 is attached to the mug 10 by any way described herein, or alternatively the heatsink is attached to the top surface of the bottom 150B of shield 150, or alternatively the heatsink is formed within shield 150 as a single solid piece. If heatsink 30 is attached to shield 150 any means such as adhesive, snap-fit, screws, bolts, intermeshing threads, or the like is used on shield 150 and heatsink 30.

Shield 150 extends any distance up sidewall 18 of mug 10. Specifically, shield 150 only extends up the sidewall 18 so as to be parallel with the top of cavity 72 so as to only cover the heatsink 30. Alternatively, shield 150 extends upwardly to the center of bottom 12, or the top of the bottom 12. Alternatively, shield 150 extends upwardly to cover the bottom ⅙, ⅕, ¼, ⅓, ½ of the beverage area 28. Alternatively, the shield extends to within 2 in., 1¾ in., 1½ in., 1¼ in., 1 in., or less than 1 in. from the top 24 of sidewall 18. Preferably enough space is left between the top of shield 150 and the top 24 of mug 10 so that the user can drink from mug 10 without their lips having to touch the shield 150. Alternatively, the shield only protects the bottom portion of beverage area 28 or the heatsink 30 so as to allow the user to see their beverage through the clear sidewall 18 of mug 10, in addition, this helps to keep the bottom of the beverage cool, which is most important to keep cool because it is the last to be consumed.

In operation, a mug 10 is matingly received by a shield 150. Either the shield 150 or the mug 10 has a heatsink 30 attached thereto. The bottom end 26 of mug 10 is positioned adjacent the top end, open end, or the end of shield 150 having seal 168 thereon. Once aligned, mug 10 is inserted within the interior of shield 150. In this position, the inward extension of seal 168 slideably and frictionally engages the exterior surface 20 of sidewall 18 of mug 10. As the mug 10 is inserted, the handle 100 is aligned with the slot 160 such that the handle 100 slides within slot 100. As the mug 10 approaches being fully inserted within shield 150 at least the bottom stem or horizontal portion on handle 100 frictionally engages the locking mechanism 176. This engagement stops the downward progression of the mug 10 into the shield 150 without increasing the pressure to overcome the locking mechanism 176. When additional pressure is applied, the locking members 178 bend or deform so as to allow this portion of the handle to pass thereby. Once the mug 10 approaches becoming fully inserted in shield 150, locking members 178 reach the opposing, or top side of the stem of handle 100 and expand back to their prior state thereby holding mug 10 within shield 150.

When mug 10 is fully inserted within shield 150, the bottom end 26 of mug 10 engages the bottom 150B of shield 150, or the compressible disk 118 which is positioned on top of bottom 150B. Also in this position, a gap 170 exists between the sidewall 150A of shield 150 and the sidewall 18 of mug 10. Protruding across the gap are a plurality of ribs 174 which connect the interior sidewall 152 of shield 150 to the exterior surface 18 of mug 10 thereby improving the rigidity of the assembly. Also, in this position the plurality of inward extensions of seal 168 seal the air within gap 170 by connecting to the exterior surface 20 of sidewall 18. Not only does this seal 168 help to hold shield 150 onto the surface of mug 10, but it helps to insulate the mug by preventing the exchange of air in and out of gap 170, and it prevents liquids from entering or exiting the gap 170.

Also, when mug 10 is fully engaged in the shield 150, the bias of spring loaded pin 183 forces pin 183 within pin hole 186. This further locks the shield 150 onto mug 10. Next, the user attaches connection member 180, such as a short strap and extends it over, across or through handle 100 and connects it to shield 150 by any means known in the art such as a button, placing a knob on the end of a resilient band and stretching it such that the band fits within a groove but the knob is does not thereby holding the shield 150 onto mug 10.

A method of using the mug includes placing the assembled mug assembly in the freezer prior to use. Then once the mug assembly 10 is cold, removing the mug assembly from the freezer and pouring a beverage into the beverage area 28 of the mug 10. The pre-chilled state of the mug 10 and shield 150 and heatsink 30 will keep the beverage cooler for longer. In addition, the shield 150 will help keep the beverage colder for longer than merely using a mug 10 without the shield 150. Alternatively, the unassembled mug 10, heatsink 30 and shield 150, or a portion of these parts are placed in the freezer. Once they are cooled they are removed, assembled and then used in the above described way. In this way an improved drinking mug assembly is presented.

In an alternative embodiment, a mug 10 is presented, as is described herein, of any size and shape. The exterior surface 20 of sidewall 18 of mug 10 has an insulating layer 200 thereon. Preferably the insulating layer 100 is any metallic material as is described herein such as aluminum, silver, gold, copper, iron, or any metallic alloy or the like. Alternatively, insulating layer 200 is a non-metallic insulating material as is described herein such as plastic, rubber, composite, UHMW, fiberglass, acrylic, or the like. Adding this layer to the glass or material of the mug prevents or slows certain forms or wavelengths of energy from passing through the sidewall 18 of mug 10, thereby insulating the mug and keeping the beverage cooler for longer.

The insulating layer 200 can be attached to any surface of mug 10, however, preferably insulating layer 200 is applied at least to the bottom portion of the exterior surface 20 of sidewall 18. Preferably the insulating layer 200 covers the entire exterior surface 20 of sidewall 18 from bottom end 26 to around 1 inch to 1½ inches from the top end 24 of sidewall 18 or in line with the top or bottom of the top stem of handle 100. Alternatively, insulating layer 200 extends any distance up sidewall 18 of mug 10 from bottom end 26. Insulating layer 200 may extend up the sidewall 18 so as stop parallel with the top of cavity 72 so as to only cover the heatsink 30. Alternatively, Insulating layer 200 extends upwardly to the center of bottom 12, or the top of the bottom 12. Alternatively, insulating layer 200 extends upwardly to cover the bottom ⅙, ⅕, ¼, ⅓, ½ of the beverage area 28. Alternatively, the insulating layer 200 extends to within 2 in., 1¾ in., 1½ in., 1¼ in., 1 in., or less than 1 in. from the top 24 of sidewall 18. Preferably enough space is left between the top of insulating layer 200 and the top 24 of mug 10 so that the user can drink from mug 10 without their lips having to touch the insulating layer 200. Alternatively, the shield only protects the bottom portion of beverage area 28 or the heatsink 30 so as to allow the user to see their beverage through the clear sidewall 18 of mug 10, in addition, this helps to keep the bottom of the beverage cool, which is most important to keep cool because it is the last to be consumed. In addition, insulating layer 200 covers the interior surface of cavity 72. In addition, insulating layer 200 covers the interior surface of beverage area 28 as is described above with respect to the exterior surface 20.

In the case of a metallic insulating layer 200, preferably the metallic insulating layer 200 is attached directly to the exterior surface 20 of sidewall 18 or it is attached with a binder, glue or adhesive positioned between the insulating layer 200 and the mug10. Preferably insulating layer 200 is attached in a manner that is durable and robust such that it can withstand the rigors of repeated use and washing, including being dishwasher safe. Insulating layer 200 can be attached to the surface of mug 10 by way of vacuum deposition directly onto the mug 10. Insulating layer 200 can be attached by painting the metallic material on the mug 10 and letting it dry, heat treating it in an oven, exposing it to various wavelengths of light such as ultraviolet, firing it in a kiln, chemical application, or any other method of curing the insulating layer onto mug 10. Insulating layer 200 can be heated, liquefied and sprayed onto the surface of mug 10. Insulating layer 200 can be applied to the surface of mug 10 in the form of a sheet such as a thin sheet of metal, or a metallic tape, metallic foil which is attached by way of adhesive, or the like.

The surface upon which insulating layer is applied can be smooth, or alternatively to improve cohesion the surface can be roughened such as scored or sand blasted or the like. To improve the durability and protect the insulating layer 200 from the rigors of use such as scratching or oxidation, a protective layer can be placed under and/or over the exterior of the insulating layer 200. This protective layer is preferably a transparent or clear layer such as a clear coat paint, a plastic, an acrylic, a fiberglass material, a composite, or any other protective layer.

Also, the above described layers can be applied in an artistic manner such as applying the insulating layer 200 in the shape of a logo or design, such as a company's logo, a team's logo, flames, scallops, a geometric pattern, a beach scene, or any other pattern or logo. The insulating layer 200 can be applied where the logo or design is to appear, or alternatively, the insulating layer 200 can be cut-out, removed or not present where the logo or design is to be located. Preferably, in this arrangement where the insulating layer is present the sidewall 18 is not transparent, whereas where the insulating layer 200 is present the sidewall 18 is opaque or not transparent.

Alternatively a logo or design is presented on the mug 10 in addition to insulating layer 200 by the addition of a logo layer. The logo layer is presented above or below the inner most or outer most insulating layers 200 so as to be seen on the inside or outside of the mug 10 so that it can be seen from the outside or inside of mug 10. Logo layer is preferably a colored layer of paint, a sticker or any other form of pigment coloring or design which can be applied to the exterior surface of mug 10. The logo layer can be presented above or below the protective layer depending on the durability of the logo layer and if a protective layer is present.

A plurality of insulating layers 200, protective layers and adhesive layers can be utilized on the mug 10 to improve performance. These combination of layers include, from the outside-in, the following:
Durable metal layer/glass
Durable metal layer/adhesive layer/glass
Durable metal layer/adhesive layer/Logo Layer/glass
Protective layer/metallic layer/glass
Protective layer/metallic layer/binder or adhesive/glass
Logo layer/Protective layer/metallic layer/binder or adhesive/glass
Protective layer/Logo Layer/metallic layer/binder or adhesive/glass

In this way a novel and improved drinking mug assembly is presented.

In an alternative embodiment, with reference to FIG. 21, a mug assembly 10 is presented wherein the heatsink 30 is held in place by way of a snap fit design. That is, heatsink 30 has a snap fit feature 250 on its exterior surface. Snap fit feature is any projection or extension out of the surface of heatsink 30. Preferably snap fit feature 250 is an o-ring 109 or has an angled upwardly facing face which transitions to a horizontal surface, resembling a fishhook barb, or when viewed from the side a triangle extending from the side of heatsink. Snap fit feature 250 is partially compressible or elastically malleable or deformable such that when the heatsink 30 is forced into the cavity 72, snap fit feature deforms allowing the heatsink 30 to be forced within cavity 72. Once the heatsink 30 is fully inserted within the cavity 72, snap fit feature 250 engages snap fit receiver 252. Snap fit receiver 252 is preferably an annular groove 74 within the sidewall of cavity 71. Alternatively, snap fit receiver 252 is a plurality of round holes, spherical holes, round notches, square notches, indentations or grooves which each receive a snap fit feature 250. In this way the heatsink 30 is locked in place.

Alternatively, snap fit feature is two, three or more partial spherical cutouts in the sidewall of cavity 72 and heatsink 30. Received within these spherical cutouts is a compressible spherical ball. Three points are used so as to properly hold the heatsink 30 within cavity 72. Alternatively any other shaped cutout and compressible object can be used.

Alternatively, a snap fit holder 254 is used which has a snap fit feature 250 on its exterior edges. When using a snap fit holder 254, the heatsink 30 is placed within cavity 72 first. Then the snap fit holder 254 is inserted in cavity 72. Like the above described snap fit feature 250 on heatsink 30, snap fit holder 254 engages snap fit receiver 252 which is preferably an annular groove 73 or plurality of notches, grooves, or indentations into the sidewall of cavity 72. Preferably snap fit holder 254 is a solid disk which fits across the entire open bottom of cavity 72. Preferably snap fit holder 254 is partially elastically malleable or deformable at its exterior edges such that when it is forced into the cavity 72, snap fit features 250 on the exterior edges of snap fit holder's 254 exterior edges deforms allowing the snap fit holder 254 to be forced within cavity 72. Once the snap fit holder 254 is fully inserted within the cavity 72, snap fit features 250 engages snap fit receiver 252. In this way the heatsink 30 is locked in place. The snap fit holder must be rigid enough to support the weight and strain of the heatsink 30 and this application. For this reason, preferably heatsink holder 254 is made of a metallic, plastic, acrylic, ceramic, composite, UHMW, or any other rigid material. To allow for the preferable amount of deformation, the edges or the snap fit feature 250 are preferably made of a plastic, or rubber material as is described above. Also, so as to help prevent water from going into the cavity 72, preferably the exterior edges of snap fit holder 254 are somewhat compressible so as to create a seal between the mug 10 and the snap fit holder. Additionally, a sealer 84 can be placed over the snap fit feature 250 once in place within mug 10 and cavity 72 to help seal heatsink 30 within cavity72 and to prevent bacteria and water from getting between mug 10 and heatsink 30.

With respect to any of the designs presented herein, marketing, logos, or designs can be applied to the mugs. Namely, marketing can be applied to the bottom, top, side or any other surface of the heatsink 30 such that the marketing can be seen through the top, bottom or side of mug 10. Alternatively, such marketing can be applied onto the surface of the lid 108, threaded ring 110, bottom plate 112, the shield 150 or any other surface of mug assembly 10. This marketing can include paint, or stickers, or pigment, or engraving shapes or designs therein, or pressing shapes or designs therein, or any other form of marketing, designs, logos or the like.

It will be appreciated by those skilled in the art that other various modifications could be made to the device without parting from the spirit and scope of this invention. All such modifications and changes fall within the scope of the claims and are intended to be covered thereby.

What is claimed is:

1. A drinking mug assembly comprising:
a bottom having a top surface and a bottom surface;
a sidewall having a top end, a bottom end, an interior surface and an exterior surface connected to and extending around the bottom;
a beverage area positioned above the bottom;
a cavity area positioned below the bottom;
a heatsink positioned within the cavity;
a lid removeably connected to the mug; and
wherein the lid holds the heatsink within the cavity.

2. The drinking mug assembly of claim 1 wherein the lid removably connects to the sidewall by threads.

3. The drinking mug assembly of claim 1 wherein the heatsink is an encapsulated thermal gel.

4. The drinking mug assembly of claim 1 wherein the heatsink is an encapsulated phase change material.

5. The drinking mug assembly of claim 1 wherein a compressible member is positioned between the mug and the lid.

6. The drinking mug assembly of claim 1 wherein the heatsink is made of a metallic material.

7. The drinking mug assembly of claim 1 further comprising a tray having at least one tray cavity which is sized and shaped such that when the tray cavity is filled with water and is frozen a frozen water heatsink is produced which matingly fits within the cavity of the drinking mug.

8. The drinking mug assembly of claim 1 wherein the lid has a double wall insulated design.

9. A drinking mug assembly comprising;
a shield;
the shield having a sidewall which extends from a top end to a bottom end;
the shield having a bottom connected to the sidewall;
the shield having a slot in the sidewall;
the shield having a seal which extends inwardly adjacent the top end of the shield; and
wherein the shield is sized and shaped to receive a mug having a handle such that when the mug is inserted in the shield the handle is received within the slot and the seal engages the surface of the mug.

10. The drinking mug assembly of claim 9 wherein the shield has a double walled design which is under a vacuum.

11. The drinking mug assembly of claim 9 wherein the shield has a double walled design which has a phase change material therein.

12. The drinking mug assembly of claim 9 further comprising a locking member connected to the shield.

13. The drinking mug assembly of claim 9 wherein the seal extends around the shield adjacent the top end of the sidewall and slot thereby sealing the space between the shield and the mug.

14. The drinking mug assembly of claim 9 further comprising a heatsink positioned within a cavity of the mug.

15. A method of using a drinking glass assembly comprising the steps of:
providing a drinking glass having a sidewall which extends from a bottom end to a top end;
placing a layer of insulating material on the sidewall;
placing the drinking glass having the insulating material thereon in a freezer;
allowing the drinking glass having the insulating material thereon to reach the ambient temperature of the freezer;
removing the drinking glass having the insulating material thereon from the freezer;
pouring a beverage into the drinking glass;
consuming the beverage while the insulating material insulates the beverage; and
wherein the drinking glass is made of a transparent material and the insulating material has at least one layer of metal.
